(19) United States
(12) Patent Application Publication
(10) Pub. No.: US 2025/0353278 A1
(43) Pub. Date: Nov. 20, 2025

(54) VACUUM INSULATED PANEL WITH THERMAL CONDUCTIVITY/DIFFUSIVITY ADDITIVE(S) FOR SEAL MATERIAL

(71) Applicant: LuxWall, Inc., Ypsilanti, MI (US)

(72) Inventor: Scott V. THOMSEN, Glen Arbor, MI (US)

(21) Appl. No.: 18/668,374

(22) Filed: May 20, 2024

(51) Int. Cl. B32B 7/05; B32B 3/08; B32B 7/14; B32B 17/06; B32B 37/06; B32B 37/12; B32B 38/00

(52) U.S. Cl. CPC B32B 7/05; B32B 3/085; B32B 7/14; B32B 17/06; B32B 37/065; B32B 37/1207; B32B 37/1292; B32B 38/0008; B32B 2037/1238; B32B 2307/302; B32B 2307/72; B32B 2309/68; B32B 2310/0843; B32B 2311/12; B32B 2315/08

(57) ABSTRACT

A vacuum insulating panel may include: a first glass substrate; a second glass substrate; a plurality of spacers provided in a gap between at least the first and second substrates, wherein the gap is at a pressure less than atmospheric pressure; and a seal having at least one layer provided between at least the first and second substrates. Additive(s) may be provided in material(s) for the seal in in order to improve thermal diffusivity and/or thermal conductivity thereof.

### FIELD

Certain example embodiments are generally related to vacuum insulated devices such as vacuum insulating panels that may be used for windows or the like, and/or methods of making same.

### BACKGROUND AND SUMMARY

Vacuum insulated panels are known in the art. For example, and without limitation, vacuum insulating panels are disclosed in U.S. Pat. Nos. 5,124,185, 5,657,607, 5,664,395, 7,045,181, 7,115,308, 8,821,999, 10,153,389, and 11,124,450, the disclosures of which are all hereby incorporated herein by reference in their entireties.

As discussed and/or shown in one or more of the above patent documents, a vacuum insulating panel typically includes an outboard substrate, an inboard substrate, a hermetic edge seal, a sorption getter, a pump-out port, and spacers (e.g., pillars) sandwiched between at least the two substrates. The gap between the substrates may be at a pressure less than atmospheric pressure to provide insulating properties. Providing a vacuum in the space between the substrates reduces conduction and convection heat transport, and thus provides insulating properties. For example, a vacuum insulating panel provides thermal insulation resistance by reducing convective energy between the two substrates, reducing conductive energy between the two transparent substrates, and reducing radiative energy with a low-emissivity (low-E) coating provided on one of the substrates. Vacuum insulating panels may be used in window applications (e.g., for commercial and/or residential windows), and/or for other applications such as commercial refrigeration and consumer appliance applications.

In certain example embodiments, a thermal diffusivity/conductivity additive(s) such as metallic copper or copper oxide (e.g., CuOₓ, where x may be from about 0.2 to 1.5, more preferably from about 0.5 to 1.4, more preferably from about 0.8 to 1.2, more preferably from about 0.9 to 1.1, with an example being about 1.0) may be added to a seal layer (e.g., main seal layer and/or primer layer(s)) in order to increase thermal diffusivity and/or absorption of the seal material so that the seal can be laser fired and/or sintered more quickly and/or more efficiently in the manufacturing process. Such an additive may result in increased thermal diffusivity and/or increased thermal conductivity of a seal layer(s) in which it is present, allowing for heat to be more easily absorbed and/or transferred through the seal material(s). For example, metallic copper and/or copper oxide may be used as a thermal diffusivity additive because it exhibits high spectral absorption from about 700 to 850 nm, including from about 750 to 815 nm (e.g., if a laser in that wavelength range is to be used). For example, the additive (e.g., CuOₓ) may allow a laser to be run faster during sintering of seal material, which may result in faster manufacturing times and/or less glass de-tempering. Such a copper oxide thermal diffusivity/conductivity additive may be replaced and/or supplemented with other additive material(s) such as one or more of molybdenum oxide, silver, silver oxide, aluminum, aluminum oxide, or the like, in various example embodiments.

In certain example embodiments, there may be provided a vacuum insulating panel comprising: a first substrate; a second substrate; a plurality of spacers provided in a gap between at least the first and second substrates, wherein the gap is at pressure less than atmospheric pressure; a seal provided at least partially between at least the first and second substrates, the seal comprising a first seal layer; and wherein the first seal layer comprises tellurium oxide and from about 0.1 to 20% (mol %) copper oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %.

In certain example embodiments, there may be provided a vacuum insulating panel comprising: a first glass substrate; a second glass substrate; a plurality of spacers provided in a gap between at least the first and second glass substrates, wherein the gap is at pressure less than atmospheric pressure; a seal provided at least partially between at least the first and second substrates, the seal comprising a seal layer; wherein the seal layer has an average D50 particle size of from about 1-25 μm (more preferably from about 1-20 μm, more preferably from about 3-20 μm, more preferably from about 5-20 μm); and wherein the seal layer comprises a metal oxide (e.g., at least one of copper oxide, silver oxide, nickel oxide, aluminum oxide, molybdenum oxide, or the like) configured to increase the thermal diffusivity and/or thermal conductivity of the seal layer compared to if the metal oxide was not present, wherein the metal oxide has an average particle size (D50) of from about 5-500 nm (more preferably from about 10-100 nm). For example, the metal oxide(s) may be at least partially in a form of metal oxide nanoparticles or colloidal nanocrystal particles.

In certain example embodiments, there may be provided a vacuum insulating panel comprising: a first substrate; a second substrate; a plurality of spacers provided in a gap between at least the first and second substrates, wherein the gap is at pressure less than atmospheric pressure; a seal provided at least partially between at least the first and second substrates, the seal comprising a first seal layer; wherein the first seal layer comprises tellurium oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %; and wherein the first seal layer further comprises from about 0.1 to 20% (mol %) of at least one of: copper oxide, molybdenum oxide, nickel oxide, aluminum oxide, and/or silver oxide.

In certain example embodiments, there may be provided a vacuum insulating panel comprising: a first glass substrate; a second glass substrate; a plurality of spacers provided in a gap between at least the first and second glass substrates, wherein the gap is at pressure less than atmospheric pressure; a seal provided at least partially between at least the first and second substrates, the seal comprising a first seal layer; wherein the first seal layer has a melting point (Tm) of from about 300 to 450 degrees C.; and wherein the first seal layer comprises tellurium oxide and from about 0.1 to 20% (mol %) copper oxide.

In certain example embodiments, there may be provided a method of making a vacuum insulating panel, the vacuum insulating panel comprising a first glass substrate, a second glass substrate, a plurality of spacers provided in a gap between at least the first and second glass substrates, and a seal provided at least partially between at least the first and second glass substrates, the seal comprising a seal layer; wherein the method comprises: providing seal material for the seal layer in a location between at least the first and second glass substrates; heating, using a laser beam from a laser, at least the seal material in order to form the seal layer; wherein the seal layer and/or the seal material comprises CuOₓ, where x is from about 0.2 to 1.5, and wherein x is based on a wavelength of the laser beam; and after forming the seal layer, evacuating the gap to a pressure less than atmospheric pressure.

In certain example embodiments, there may be provided a method of making a vacuum insulating panel, the vacuum insulating panel comprising a first glass substrate, a second glass substrate, a plurality of spacers provided in a gap between at least the first and second glass substrates, and a seal provided at least partially between at least the first and second glass substrates, the seal comprising a seal layer; wherein the method comprises: providing first seal material for the seal layer in a location between at least the first and second glass substrates; heating, using a laser beam from a laser, at least the seal material in order to form the seal layer; wherein the seal layer comprises from about 0.1 to 20% (mol %) of at least one of: copper, copper oxide, molybdenum oxide, nickel oxide, aluminum, aluminum oxide, and/or silver oxide; wherein said at least one of copper, copper oxide, molybdenum oxide, nickel oxide, aluminum, aluminum oxide, and/or silver oxide is configured to increase a thermal diffusivity and/or thermal conductivity of the seal layer and so as to have a peak and/or high absorption within about 150 nm of the wavelength of the laser beam; and after forming the seal layer, evacuating the gap to a pressure less than atmospheric pressure.

In certain example embodiments, there may be provided a vacuum insulating panel comprising: a first substrate; a second substrate; a plurality of spacers provided in a gap between at least the first and second substrates, wherein the gap is at pressure less than atmospheric pressure; a seal provided at least partially between at least the first and second substrates, the seal comprising a first seal layer and a second seal layer; wherein the first seal layer comprises tellurium oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %; wherein the second seal layer comprises boron oxide and/or bismuth oxide; wherein at least one of the first and second seal layers comprises from about 0.1 to 20%, more preferably from about 1-20%, more preferably from about 1-15%, more preferably from about 2-10%, and most preferably from about 2-5% (mol %) of at least one of: copper, copper oxide, molybdenum oxide, nickel oxide, aluminum, aluminum oxide, and/or silver oxide.

Technical advantage(s), for example, include one or more of: improved heat transfer through material(s) during manufacturing; faster firing/sintering of seal material; less de-tempering of glass; improved U-value performance; reduced improved lamination at seal interface(s), improved seal durability, less seal defects, and/or reduced transient induced thermal stress in seal and/or glass material(s).

### BRIEF DESCRIPTION OF THE DRA WINGS

These and/or other aspects, features, and/or advantages will become apparent and more readily appreciated from the following description of various example embodiments, taken in conjunction with the accompanying drawings. Thicknesses of layers/elements, and sizes of components/elements, are not necessarily drawn to scale or in actual proportion to one another, but rather are shown as example representations. Like reference numerals may refer to like parts throughout the several views. Each embodiment herein may be used in combination with any other embodiment(s) described herein.

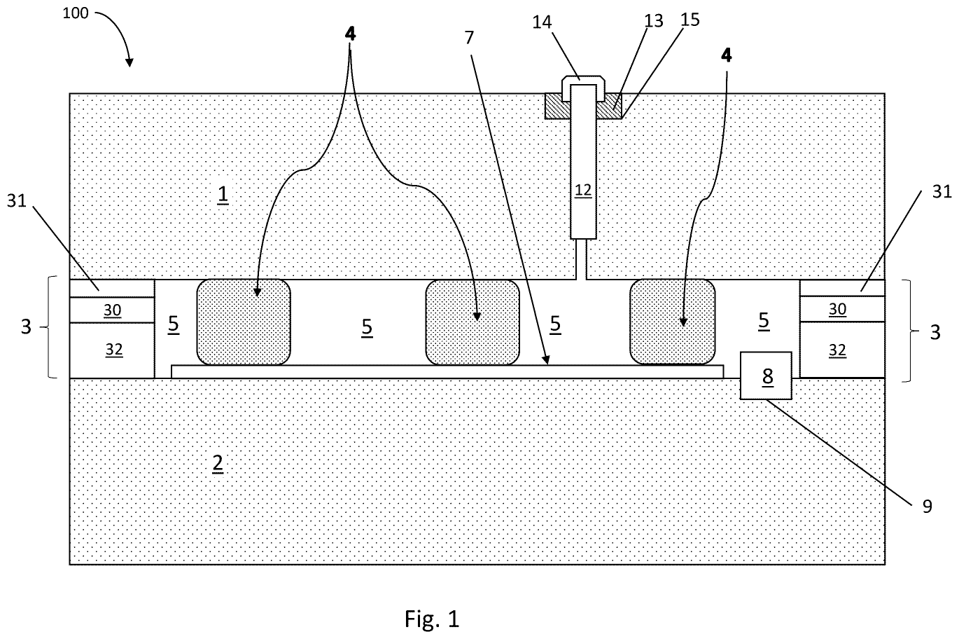

FIG. 1 is a side cross sectional view of a vacuum insulating unit/panel according to an example embodiment.

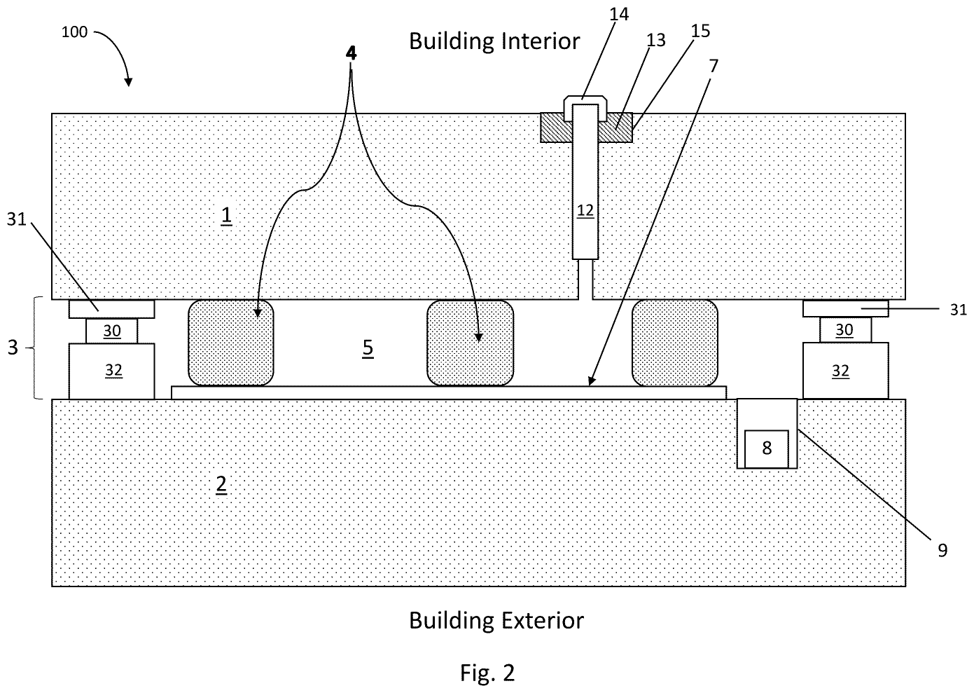

FIG. 2 is a side cross sectional view of a vacuum insulating unit/panel according to an example embodiment.

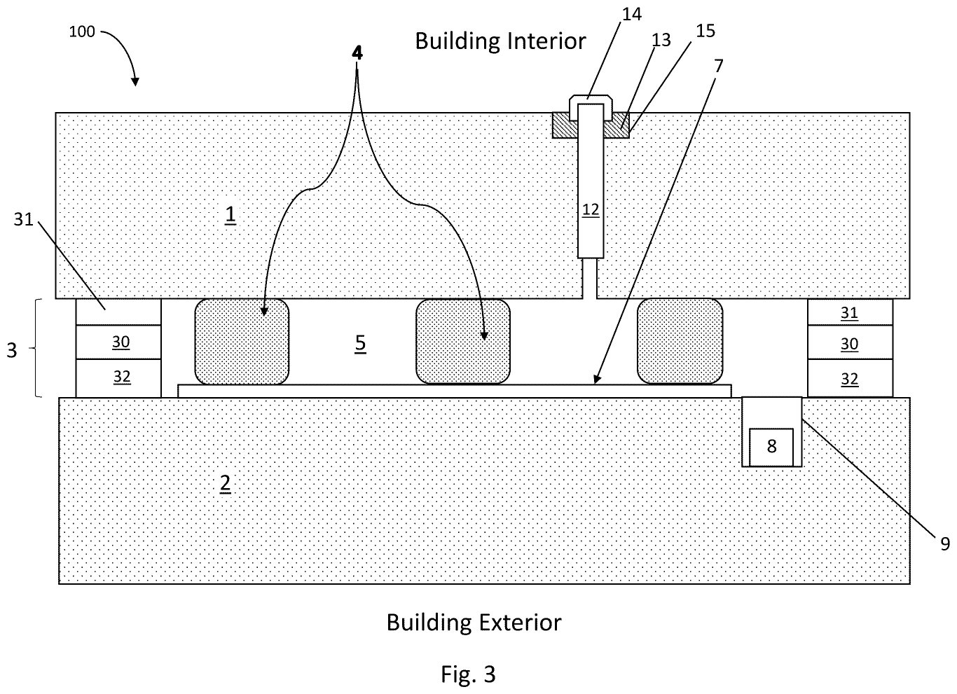

FIG. 3 is a side cross sectional view of a vacuum insulating unit/panel according to an example embodiment.

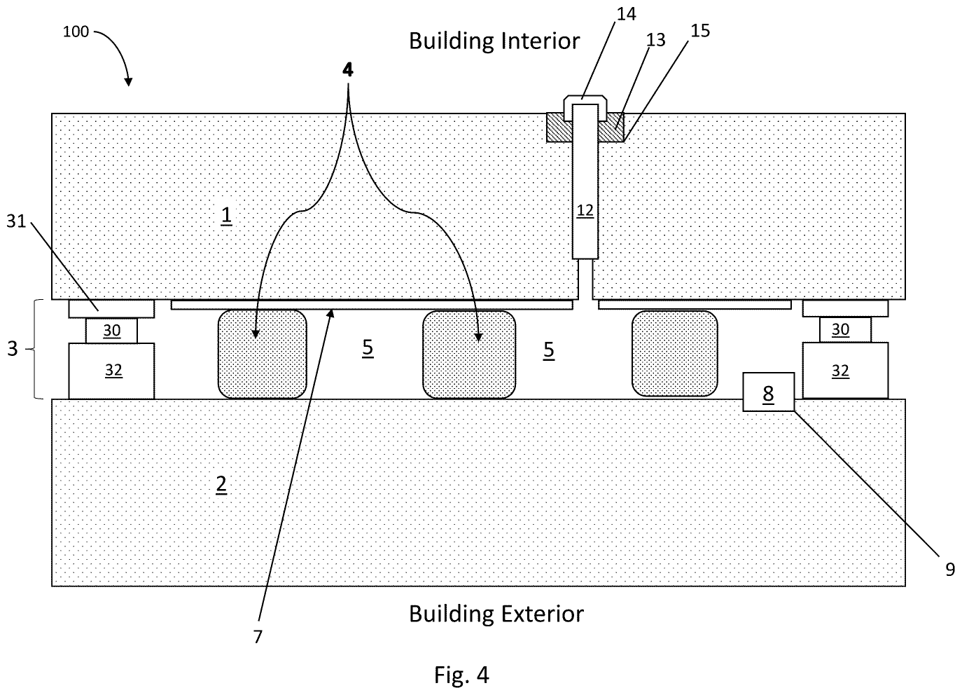

FIG. 4 is a side cross sectional view of a vacuum insulating unit/panel according to an example embodiment.

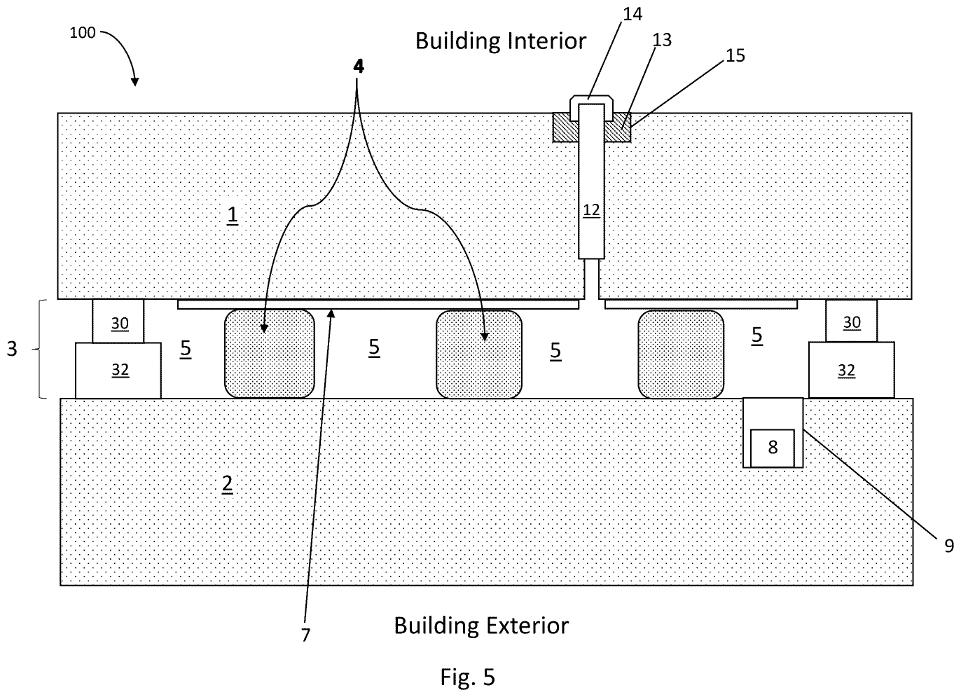

FIG. 5 is a side cross sectional view of a vacuum insulating unit/panel according to an example embodiment.

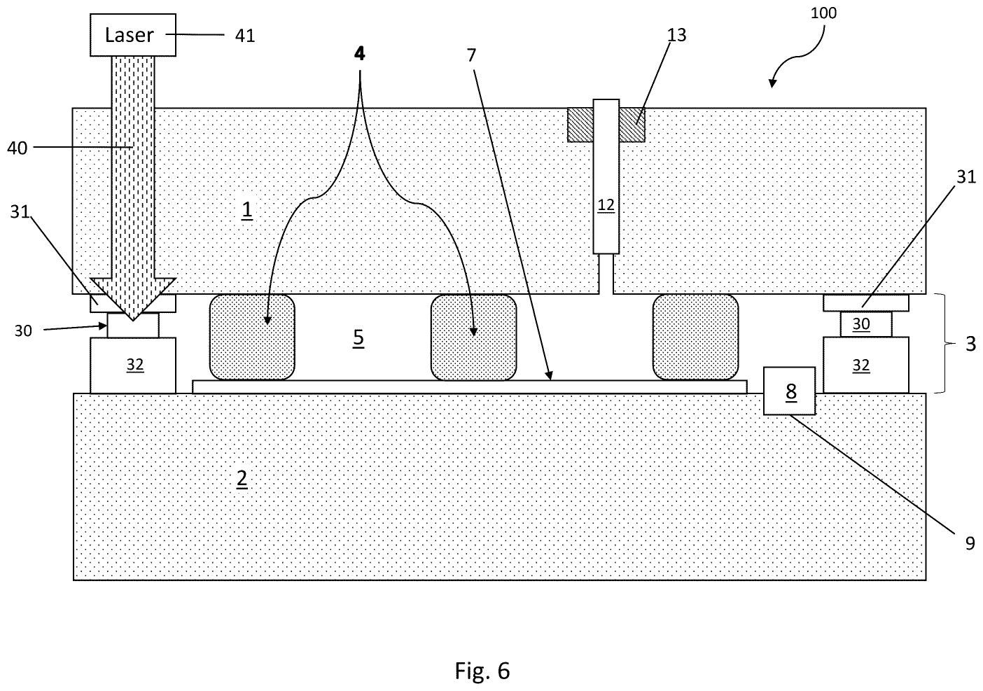

FIG. 6 is a side cross sectional schematic view of a vacuum insulating unit/panel according to an example embodiment, showing a laser being used in forming the edge seal during manufacturing, which may be used in combination with any embodiment herein including those of FIGS. 1-16.

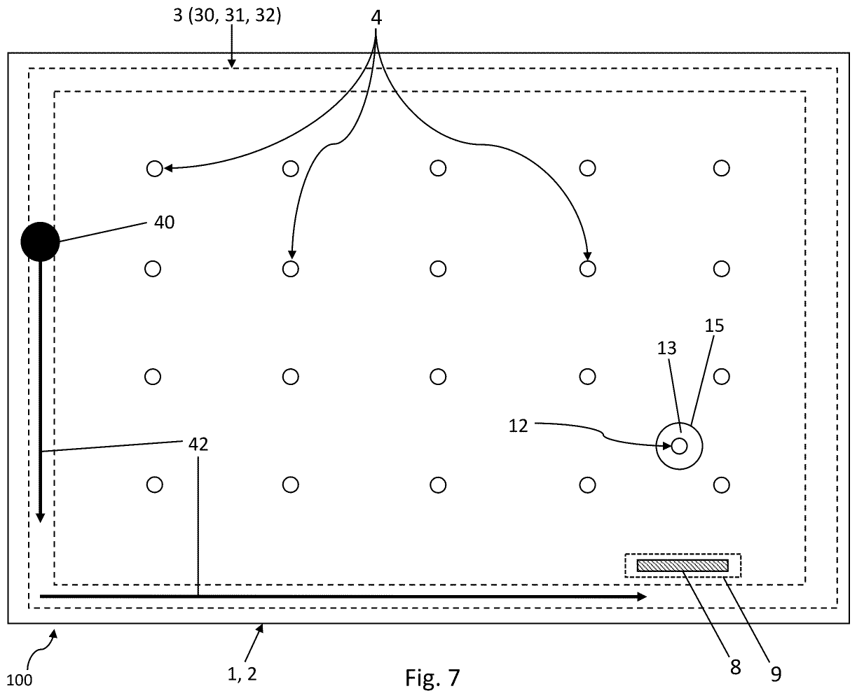

FIG. 7 is a schematic top view of a vacuum insulating unit/panel according to an example embodiment, showing a laser used in forming the edge seal during manufacturing, which may be used in combination with any embodiment herein including those of FIGS. 1-16.

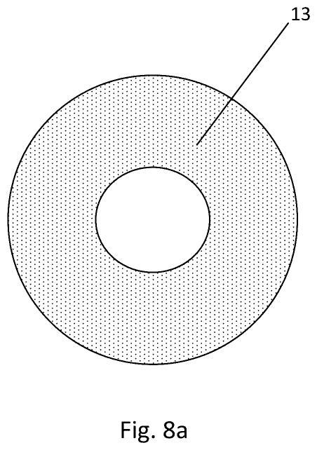

FIG. 8a is a top view of a ceramic preform to be used for a pump-out tube seal according to an example embodiment, which may be used in combination with any embodiment herein including those of FIGS. 1-16.

FIG. 8b is a cross-sectional view of a ceramic preform seal of FIG. 8a, surrounding a pump-out tube, according to an example embodiment, which may be used in combination with any embodiment herein including those of FIGS. 1-16.

FIG. 8c is a schematic cross-sectional diagram of the seal preform of FIGS. 8a-8b being laser sintered, according to an example embodiment, which may be used in combination with any embodiment herein including those of FIGS. 1-16.

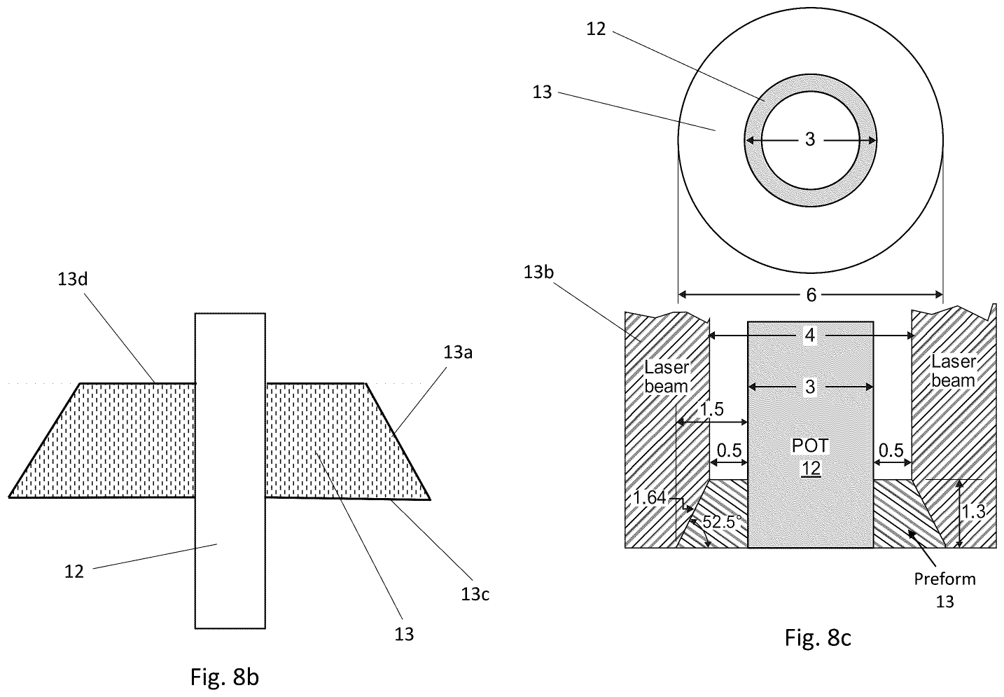

FIG. 9 is a side cross sectional view of an example edge seal for a vacuum insulating unit/panel according to an example embodiment, taken at the edge of a panel, with example layer thicknesses, which may be used in combination with any embodiment herein including those of FIGS. 1-16.

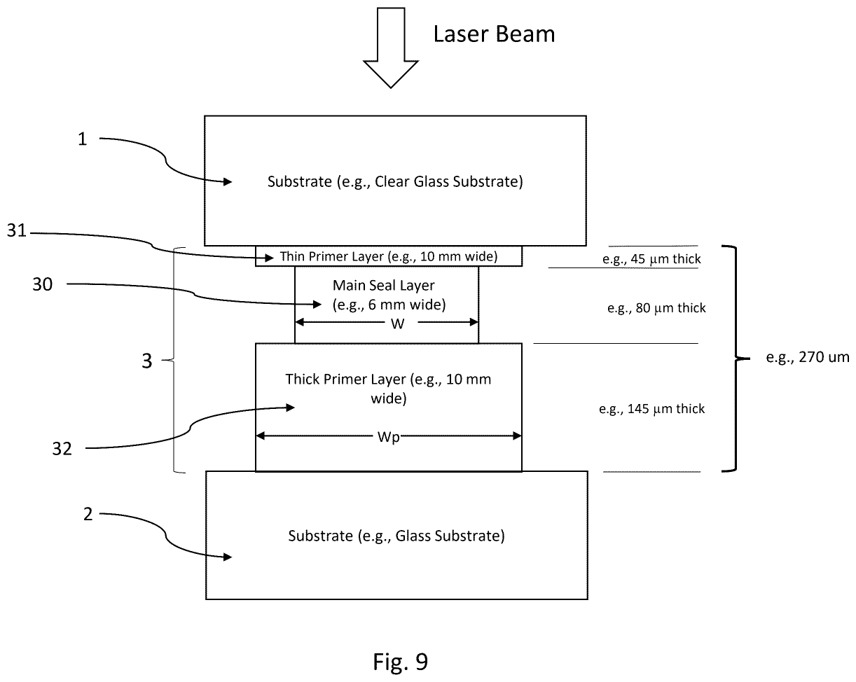

FIG. 10 is a % Tempering Strength Remaining vs. Time graph illustrating that de-tempering of glass is a function of temperature and time.

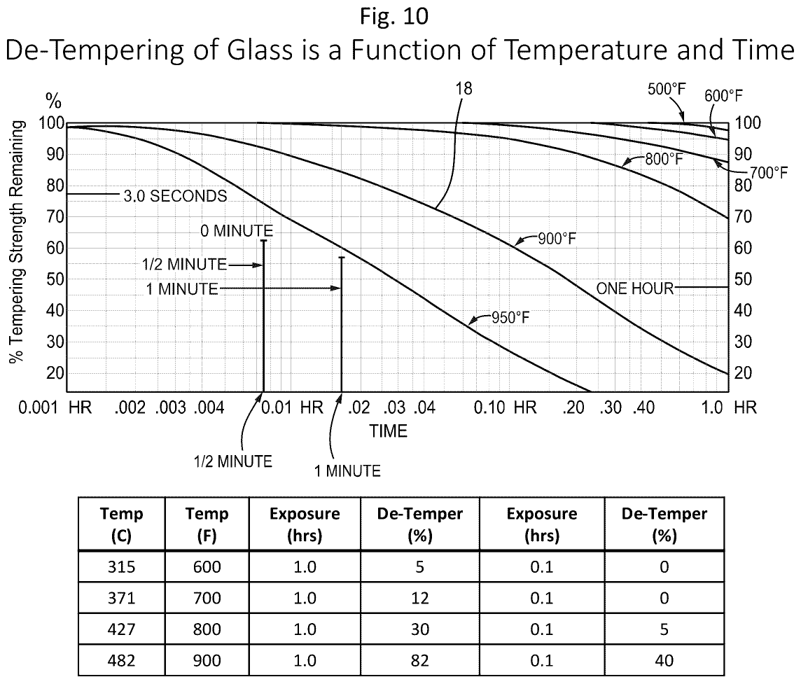

FIG. 11 is a table/graph showing weight % and mol % of various compounds/elements in a main seal material according to an example embodiment (measured via non-carbon detecting XRF), which main seal material may be used in combination with any embodiment herein including those of FIGS. 1-16.

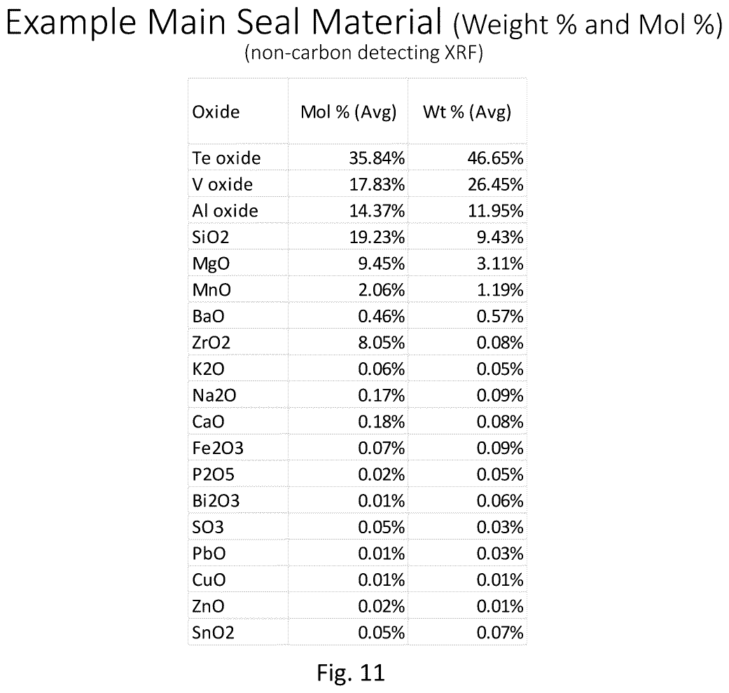

FIG. 12 is a table/graph showing weight % and mol % of various compounds/elements in a main seal material according to an example embodiment (measured via carbon detecting XRF), before and after laser treatment using an 808 or 810 nm continuous wave laser for edge seal formation, which main seal material may be used in combination with any embodiment herein including those of FIGS. 1-16.

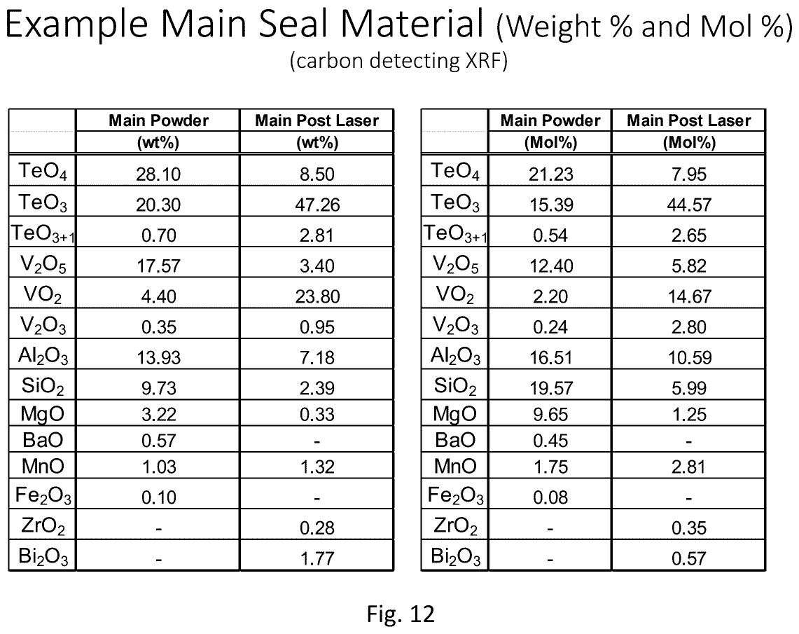

FIG. 13 is a table/graph showing weight % and mol % of various compounds/elements in a primer seal material according to an example embodiment (measured via carbon detecting XRF), before and after substrate tempering, which primer material may be used in combination with any embodiment herein (e.g., for one or both primer layers) including those of FIGS. 1-16.

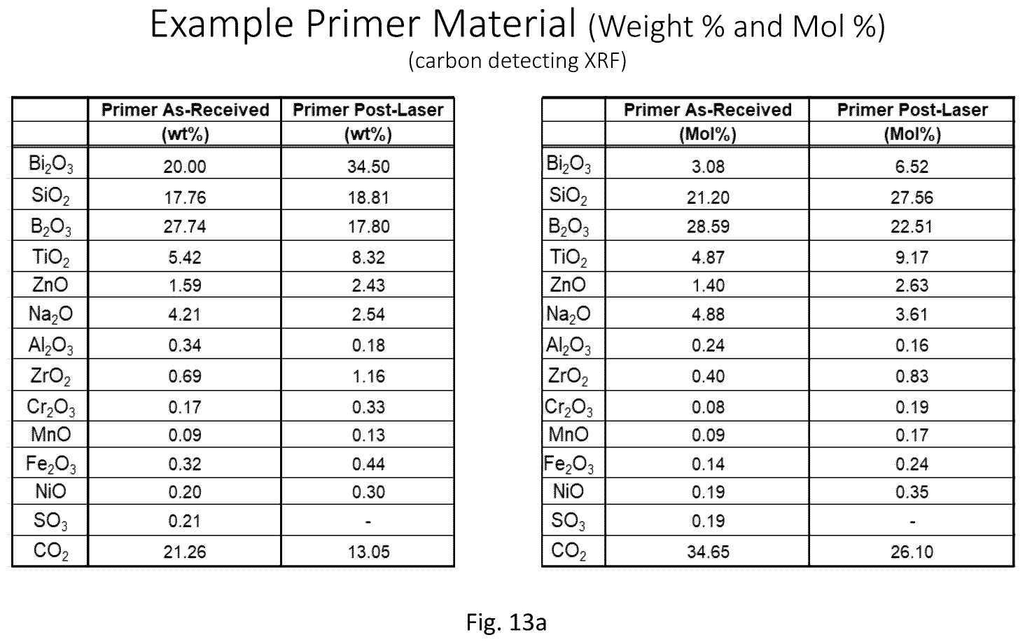

FIG. 14 is a table/graph showing an elemental analysis (non-oxide analysis) of weight % and mol % of various elements in each of a main seal material (left side in the figure), a pump-out tube seal material (center in the figure), and a primer seal material (right side in the figure), according to an example embodiment(s) (measured via WDXRF), before and after laser treatment using an 808 or 810 nm continuous wave laser to fire/sinter the main seal layer for seal formation, which various seal materials may be used in combination with any embodiment herein including those of FIGS. 1-16.

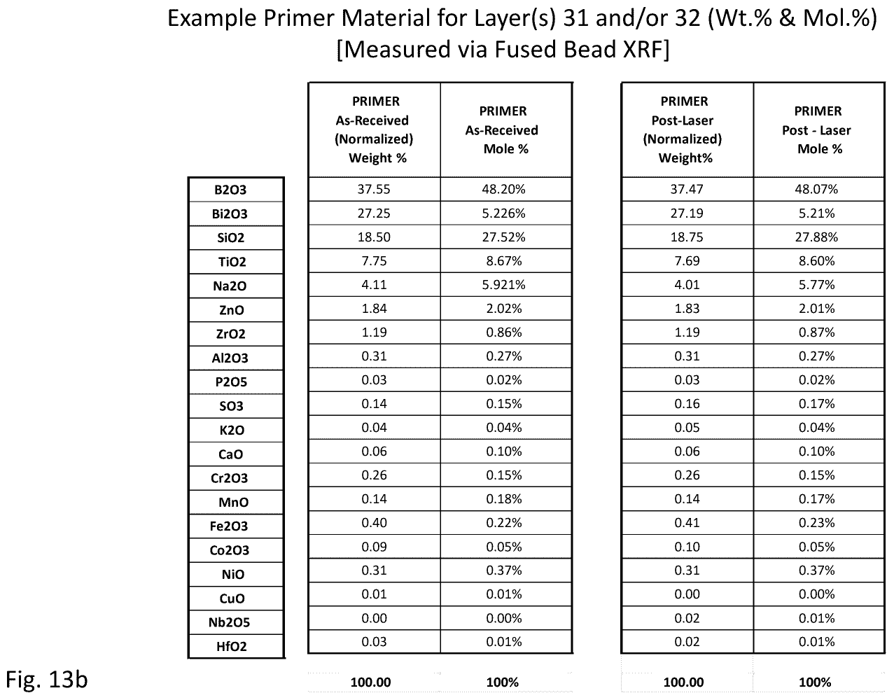

FIG. 15 is a table/graph showing density (g/cm³) vs. temperature (degrees C.) for two different example main seal materials according to example embodiments, which seal material(s) may be used in combination with any embodiment herein including those of FIGS. 1-16.

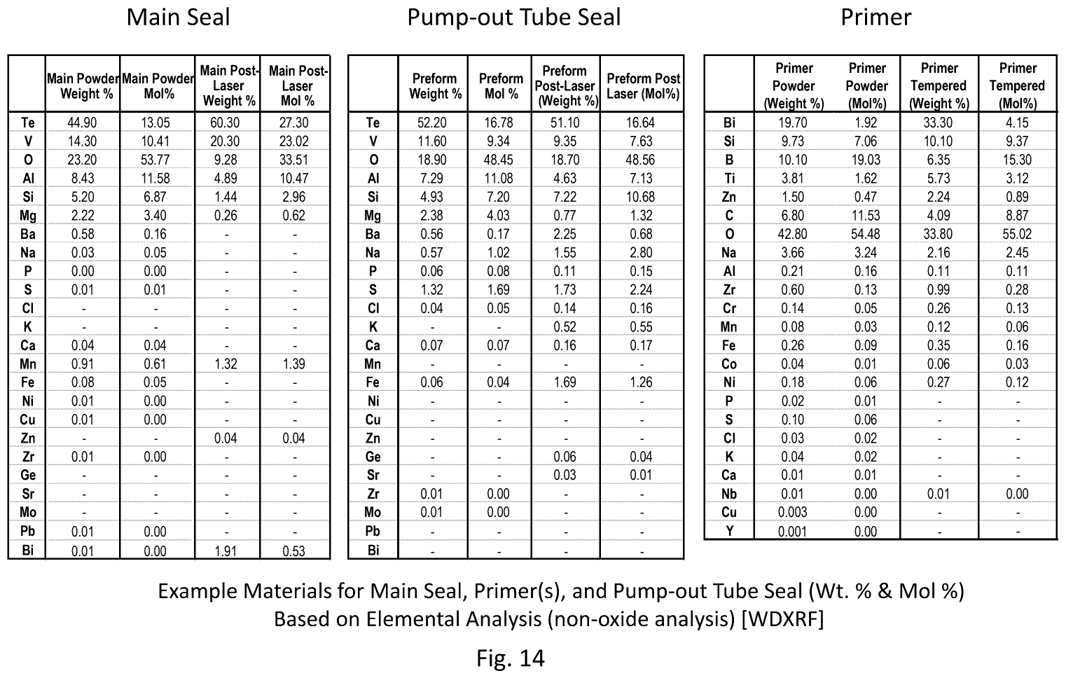

FIG. 16 is a flowchart illustrating example steps in making a vacuum insulating panel according to various example embodiments, which may be used in combination with any embodiment herein including those of FIGS. 1-15.

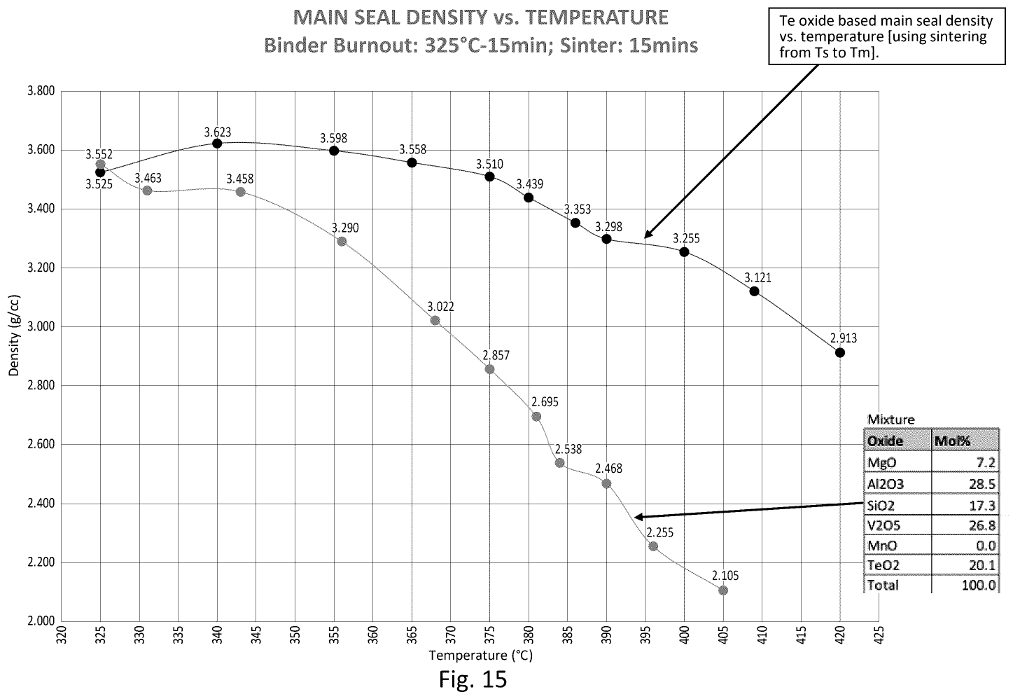

FIG. 17 is an absorption vs. wavelength (nm) graph illustrating absorbance at different wavelengths of various oxidation states of copper oxide.

### DETAILED DESCRIPTION

The following detailed structural and/or functional description(s) is/are provided as examples only, and various alterations and modifications may be made. The example embodiments herein do not limit the disclosure and should be understood to include all changes, equivalents, and replacements within ideas and the technical scope herein. Hereinafter, certain examples will be described in detail with reference to the accompanying drawings. When describing various example embodiments with reference to the accompanying drawings, like reference numerals may refer to like components and a repeated description related thereto may be omitted.

Conventional insulated glass edge sealing systems and associated sintering and/or firing processes have shown it is possible to create a hermetically sealed vacuum insulating panel. However, conventional vacuum insulated glass perimeter sealing systems may suffer from one or more of the following drawbacks that hinder use of such products commercially: (1) significant de-tempering of the glass substrate(s) preventing or reducing a likelihood of the vacuum insulated panel meeting mandatory tempered glass safety codes due to overall reduction in the compressive surface stress across the device and/or the internal tensile stress; (2) significantly higher de-tempering rates around the periphery of the device relative to the center of the vacuum insulated panel resulting in a large compressive stress gradient that upon physical impact does not meet safety fragmentation requirements, due for example and without limitation at least to variations in resonant vibration frequencies; (3) lack of durability, for example due to thermally induced breakage or flaws from large asymmetric thermal stress across the unit and/or spacer induced cracks causing glass breakage; (4) lack of durability and/or hermiticity due to edge seal damage, cracks and/or flaws; (5) slow processing times, for example for seal sintering resulting in high manufacturing costs; (6) increased need for heat soak testing to ensure that the unit contains no latent defects; and/or (7) significant thermal de-tempering of tempered glass resulting in higher unit breakage rates such as when installed in a final application. Certain example embodiments herein may overcome at least one of these problems.

Thermal heating methods and/or processes have been employed to sinter and/or fire ceramic sealing glass materials around the perimeter of the vacuum insulated glass panels. Such methods include batch oven systems using a combination of radiation and convective heating, in-line oven systems using a combination of radiation and convective heating, millimeter microwave selective perimeter heating, short wave infrared selective perimeter heating and laser perimeter heating. While each of these heating techniques may be used, for different type(s) of heating in various example embodiments, they do have one or more drawbacks in certain instances. Batch and in-line thermal processes that employ no selective heating techniques are sometimes not viable options for achieving tempered vacuum insulated glass units when the unit is exposed to high temperatures for long durations of time which significantly de-tempers the glass substrates, and/or may have high manufacturing costs due to low output and high utility costs related to thermal heating. Millimeter microwave involves high capital equipment costs, and long process cycle times, resulting in high manufacturing costs. Short wave infrared energy often cannot be directed to a narrow enough band around the perimeter of the glass, and thus can result in high levels of de-tempering of tempered glass at the perimeter which results in a high center to perimeter gradient and a lack of durability for the final panel, and resulting products have difficulty with safety impact tests (e.g., safety bag impact and/or fragmentation tests) and/or pass edge of glass compressive stress standards. Prior efforts to utilize laser heating of the perimeter seal have also been problematic. An example issue with prior laser heating is that extremely rapid heating and cooling from the laser beam over large temperature ranges creates high transient stress conditions in the perimeter sealing glass material(s) and/or glass substrate thereby leading to micro-cracks in the sealing structure which leads to one or more of hermeticity issues (loss of vacuum), structural issues during asymmetric thermal loading (e.g., unit failure resulting in loss of vacuum), poor moisture and/or high humidity resistance resulting in premature failure (e.g., loss of vacuum) in the product end application, and/or high manufacturing costs due to low lasing speeds. Past laser selective approaches have not employed sufficient structures and/or techniques to significantly reduce transient stress and/or final residual stress.

Need(s) exist in the field for a vacuum insulated glass panel/device and/or corresponding technique(s), so that one or more of the above identified problems can be solved. For example, it may be desirable to provide a vacuum insulating panel capable of one or more of: (a) maintaining vacuum hermeticity, (b) maintaining in one or both glass substrates, when thermally tempered, a surface compressive stress of at least about 10,000 psi, more preferably of at least about 11,000 psi, more preferably of at least about 12,000 psi, more preferably of at least about 13,000 psi, and sometimes at least about 14,000 psi, after fabrication of the vacuum insulated glass panel, (c) maintaining in one or both glass substrates, when thermally tempered, an internal tensile stress of at least about 5,200 psi, more preferably at least about 5,500 psi, more preferably at least about 6,000 psi, more preferably at least about 6,500 psi, and most preferably at least about 7,000 psi and/or at least about 7,500 psi, after fabrication of the vacuum insulating panel, (d) maintaining in one or both glass substrates, when thermally tempered, an edge stress of at least about 9,700 psi after fabrication of the vacuum insulated panel, (e) maintaining in one or both glass substrates, when thermally tempered, a maximum center to edge and/or a center to corner stress gradient of no more than 2,000 psi, more preferably of no more than 1,000 psi, or no more than 500 psi, in a panel capable of maintaining structural integrity such as during extended exposure to an asymmetric thermal differential of 70 degrees C., more preferably 90 degrees C., (f) providing an improved edge seal structure, (g) providing improved processing for forming the edge seal, (h) providing structure and/or processing technique(s) for reducing chances of significant de-tempering of glass substrate(s), (i) providing structure and/or processing for reducing induced transient thermal stress in glass substrate(s) and/or sealing material, (j) providing structure and/or processing for improving sealing functionality and/or strength of a seal, (k) providing structure and/or processing for improving durability and/or aesthetics of a vacuum insulating panel, and/or (l) providing structure and/or processing permitting the product to be cost effectively produced in a time efficient manner. Various example embodiments herein address different need(s), such that any given embodiment may address at least one of the above needs in certain example instances.

FIGS. 1-5 are side cross sectional views each illustrating a vacuum insulating panel 100 according to various example embodiments, FIG. 6 is a side cross sectional view of an example vacuum insulating unit/panel 100 showing a laser used in sintering/firing the main seal layer 30 when forming the edge seal 3 during manufacturing (which may be used in combination with any embodiment herein, and FIG. 7 is a schematic top view of an example vacuum insulating unit/panel 100 showing a laser used in sintering/firing the main seal layer 30 when forming the edge seal 3 during manufacturing (which may be used in combination with any embodiment herein). It should be noted that, in practice, such vacuum insulating panels/units may be oriented upside down or sideways from the orientations illustrated in FIGS. 1-7. Vacuum insulating panel 100 may be used in window applications (e.g., for commercial and/or residential windows), and/or for other applications such as commercial refrigeration and consumer appliance applications.

Referring to FIGS. 1-7, each vacuum insulating panel 100 may include a first substrate 1 (e.g., glass substrate), a second substrate 2 (e.g., glass substrate), a hermetic edge seal 3 at least partially provided proximate the edge of the panel 100, and a plurality (e.g., an array) of spacers 4 provided between at least the substrates 1 and 2 for spacing the substrates from each other and so as to help provide low-pressure space/gap 5 between at least the substrates. Each glass substrate 1, 2 may be flat, or substantially flat, in certain example embodiments. Support spacers 4, sometimes referred to as pillars, may be of any suitable shape (e.g., round, oval, disc-shaped, square, rectangular, rod-shaped, etc.) and may be of or include any suitable material such as stainless steel, aluminum, ceramic, solder glass, metal, and/or glass. Certain example support spacers 4 shown in the figures are substantially circular as viewed from above and substantially rectangular as viewed in cross section, and may have rounded edges. The hermetic edge seal 3 may include one or more of main seal layer 30, upper primer layer 31, and lower primer layer 32. Each “layer” herein may comprise one or more layers. At least one thermal control and/or solar control coating 7, such as a multi-layer low-emittance (low-E) coating, may be provided on at least one of the substrates 1 and 2 in order to further improve insulating properties of the panel. The solar control coating 7 may be provided on substrate 1 or substrate 2, or such a solar control coating may be provided on both substrates 1 and 2. For example, FIGS. 1-3 and 6 illustrate such a coating 7 (e.g., low-E coating) provided on substrate 2, whereas FIGS. 4-5 illustrate the coating 7 provided on substrate 1. Each substrate 1 and 2 is preferably of or including glass, but may instead be of other material such as plastic or quartz. For example, one or both glass substrates 1 and 2 may be soda-lime-silica based glass substrates, borosilicate glass substrates, lithia aluminosilicate glass substrates, or the like, and may be clear or otherwise tinted/colored such as green, grey, bronze, or blue tinted. Substrates 1 and 2, in certain example embodiments, may each have a visible transmission of at least about 40%, more preferably of at least about 50%, and most preferably of from about 60-80%. The vacuum insulating panel 100, in certain example embodiments, may have a visible transmission of at least 40%, more preferably of at least 50%, and most preferably of at least 60%. The substrates 1 and 2 may be substantially parallel (parallel plus/minus ten degrees, more preferably plus/minus five degrees) to each other in certain example embodiments. Substrates 1 and 2 may or may not have the same thickness, and may or may not be of the same size and/or same material, in various example embodiments. When glass is used for substrates 1 and 2, each of the glass substrates may be from about 1-12 mm thick, more preferably from about 3-8 mm thick, and most preferably from about 4-6 mm thick. When glass is used for substrates 1 and 2, the glass may or may not be tempered (e.g., thermally tempered). Although thermally tempered glass substrates are desirable in certain environments, the glass substrate(s) may be heat strengthened in certain example embodiments. As known in the art, thermal tempering of glass typically involves heating the glass to a temperature of at least 585 degrees C., more preferably to at least 600 degrees C., more preferably to at least 620 degrees C. (e.g., to a temperature of from about 6209-650 degrees C.), and then rapidly cooling the heated glass so as to compress surface regions of the glass to make it stronger. The glass substrates may be thermally tempered to increase compressive surface stress and to impart safety glass properties including small fragmentation upon breakage. When tempered glass substrates 1 and/or 2 are used, the substrate(s) may be tempered (e.g., thermally or chemically tempered) prior to firing/sintering of main edge seal material 30 (e.g., via laser) to form the edge seal 3.

Heat strengthening of the glass substrates involves the same temperature ranges as tempering, but does not include the rapid cooling/quenching. When heat strengthened glass substrates 1 and/or 2 are used, the substrate(s) may be heat strengthened prior to firing/sintering of the main edge seal material 30 (e.g., via laser) to form the edge seal 3. When a vacuum insulated glass panel/unit has one tempered glass substrate and one heat strengthened substrate, the substrate(s) may be tempered (e.g., thermally or chemically tempered) and heat strengthened prior to firing/sintering of the main edge seal material 30 (e.g., via laser) to form the edge seal 3.

In various example embodiments, each vacuum insulating panel 100, still referring to FIGS. 1-7, optionally may also include at least one sorption getter 8 (e.g., at least one thin film getter) for helping to maintain the vacuum in low pressure space 5 by using reactive material for soaking up and/or bonding to gas molecules that remain in space 5, thus providing for sorption of gas molecules in low pressure space 5. The getter 8 may be provided directly on either glass substrate 1 or 2, or may be provided on a low-E coating 7 in certain example embodiments. In certain example embodiments, the getter 8 may be laser-activated and/or activated using inductive heating techniques, and/or may be positioned in a trough/recess 9 that may be formed in the supporting substrate (e.g., substrate 2) via laser etching, laser ablating, and/or mechanical drilling.

A vacuum insulating panel 100 may also include a pump-out tube 12 used for evacuating the space 5 to a pressure(s) less than atmospheric pressure, where the elongated pump-out tube 12 may be closed/sealed after evacuation of the space 5. Pump-out seal 13 may be provided around tube 12, and a cap 14 may be provided over the top of the tube 12 after it is sealed. Tube 12 may extend part way through the substrate 1, for example part way through a double countersink hole drilled in the substrate as shown in FIGS. 1-6. However, tube 12 may extend all the way through the substrate 1 in alternative example embodiments. Pump-out tube 12 may be of any suitable material, such as glass, metal, ceramic, or the like. In certain example embodiments, the pump-out tube 12 may be located on the side of the vacuum insulating panel 100 configured to face the interior of the building when the panel is used in a commercial and/or residential window. In certain example embodiments, the pump-out tube 12 may instead be located on the side of the vacuum insulating panel 100 configured to face the exterior of the building. The pump-out tube 12 may be provided in an aperture defined in either substrate 1 or 2 in various example embodiments. Pump-out seal 13 may be of any suitable material. In certain example embodiments, the pump-out seal 13 may be provided in the form of a substantially donut-shaped pre-form which may be positioned in a recess 15 formed in a surface of the substrate 1 or 2, so as to surround an upper portion of the tube 12, so that the pre-form can be laser treated/fired/sintered (e.g., after formation of the edge seal 3) to provide a seal around the pump-out tube 12. Alternatively, the pump-out seal 13 may be of any suitable material and/or may be dispensed in paste and/or liquid form to surround at least part of the tube 12 and may be sealed before and/or after evacuation of space 5. The pump-out seal material 13 may be directly applied to the glass substrate material or to a primer layer applied to the glass substrate surface prior to the pump-out seal material being applied to the substrate, in certain example embodiments. After evacuation of space 5, the tip of the tube 15 may be melted via laser to seal same, and hermetic sealing of the space 5 in the panel 100 can be provided both by the edge seal 3 and by the sealed upper portion of the pump-out tube 12 together with seal 13 and/or cap 14. In certain example embodiments, as shown in FIGS. 1-7 for example, the elongated pump-out tube 12 may be substantially perpendicular (perpendicular plus/minus ten degrees, more preferably plus/minus five degrees) to the substrates 1 and 2. Any of the elements/components shown in FIGS. 1-7 may be omitted in various example embodiments.

The evacuated gap/space 5 between the substrates 1 and 2, in the vacuum insulating panel 100, is at a pressure less than atmospheric pressure. For example, after the edge seal 3 has been formed, the cavity 5 evacuated to a pressure less than atmospheric pressure, and the pump-out tube 12 closed/sealed, the gap 5 between at least the substrates 1 and 2 may be at a pressure no greater than about 1.0×10⁻² Torr, more preferably no greater than about 1.0×10⁻³ Torr, more preferably no greater than about 1.0×10⁻⁴ Torr, and for example may be evacuated to a pressure no greater than about 1.0×10⁻⁶ Torr. The gap 5 may be at least partially filled with an inert gas in various example embodiments. In certain example embodiments, the evacuated vacuum gap/space 5 may have a thickness (in a direction perpendicular to planes of the substrates 1 and 2) of from about 100-1,000 μm, more preferably from about 200-500 μm, and most preferably from about 230-350 μm. Providing a vacuum in the gap/space 5 is advantageous as it reduces conduction and convection heat transport, so as to reduce temperature fluctuations inside buildings and the like, thereby reducing energy costs and needs to heat and/or cool buildings. Thus, panels 100 can provide high levels of thermal insulation.

Example low-emittance (low-E) coatings 7 which may be used in the vacuum insulating panel 100 are described in U.S. Pat. Nos. 5,935,702, 6,042,934, 6,322,881, 7,314,668, 7,342,716, 7,632,571, 7,858,193, 7,910,229, 8,951,617, 9,215,760, and 10,759,693, the disclosures of which are all hereby incorporated herein by reference in their entireties. Other low-E coatings may also, or instead, be used. A low-E coating 7 typically includes at least one IR reflecting layer (e.g., of or including silver, gold, or the like) sandwiched between at least first and second dielectric layer(s) of or including materials such as silicon nitride, zinc oxide, zinc stannate, and/or the like. A low-E coating 7 may have one or more of: (i) a hemispherical emissivity/emittance of no greater than about 0.20, more preferably no greater than about 0.04, more preferably no greater than about 0.028, and most preferably no greater than about 0.015, and/or (ii) a sheet resistance (Rₛ) of no greater than about 15 ohms/square, more preferably no greater than about 2 ohms/square, and most preferably no greater than about 0.7 ohms/square, so as to provide for solar control. In certain example embodiments, the low-E coating 7 may be provided on the interior surface of the glass substrate to be closest to the building exterior, which is considered surface two (e.g., see FIGS. 2-3), whereas in other example embodiments the low-E coating 7 may be provided on the interior surface of the glass substrate to be closest to the building interior, which is considered surface three (e.g., see FIGS. 4-5).

FIG. 1 illustrates an embodiment where the edge seal 3 is provided in the vacuum insulated glass panel 100 at the absolute edge, the seal layers 30, 31 and 32 all have substantially the same width (e.g., between about 6 mm and 12 mm), and a thickness of the main seal layer 30 is less than a thickness of primer layer 31 but greater than a thickness of the other primer layer 32. FIG. 2 illustrates an embodiment where the edge seal 3 is spaced inwardly from the absolute edge of the panel 100, the width of the main seal layer 30 is less than a width(s) of the primer layers 31 and 32, and a thickness of the main seal layer 30 is greater than a thickness of primer layer 31 but less than a thickness of the other primer layer 32. FIG. 3 illustrates an embodiment where the edge seal 3 is spaced inwardly from the absolute edge of the panel 100, the seal layers 30, 31 and 32 all have substantially the same width (e.g., between about 6 mm and 12 mm), and the seal layers 30, 31 and 32 all have substantially the same thickness. FIG. 4 illustrates an embodiment where the edge seal 3 is spaced inwardly from the absolute edge of the panel 100, the width of the main seal layer 30 is less than a width(s) of the primer layers 31 and 32, a thickness of the main seal layer 30 is greater than a thickness of primer layer 31 but less than a thickness of primer layer 32, and the low-E coating 7 is provided on substrate 1 (as opposed to the low-E coating being on substrate 2 in FIGS. 1-3). FIG. 5 illustrates an embodiment similar to FIG. 4, except that primer layer 31 is omitted in the FIG. 5 embodiment (note that primer layer 32 may also be omitted in certain example embodiments). FIG. 6 provides an example where a laser beam 40 from laser 41 is being used to heat the edge seal structure for sintering/firing the main seal layer 30 to form the hermetic edge seal 3, and FIG. 7 is a top view illustrating the laser beam 40 proceeding around the entire periphery of the panel along path 42 over the edge seal layers 30-32 to fire/sinter the main edge seal layer 30 in forming the hermetic edge seal 3. The laser beam 40 performs localized heating of the edge seal area, so as to not unduly heat certain other areas of the panel thereby reducing chances of significant de-tempering of the glass substrates. Each of these embodiments may be used in combination with any other embodiment described herein, in whole or in part.

Edge seal 3, which may include one or more of ceramic layers 30-32, may be located proximate the periphery or edge of the vacuum insulated panel 100 as shown in FIGS. 1-7. Edge seal 3 may be a ceramic edge seal in certain example embodiments. Referring to FIGS. 1-6, in certain example embodiments, layer 30 of the edge seal may be considered a main or primary seal layer, and layers 31 and 32 may be considered primer layers. One or more of seal layers 30-32, of the edge seal 3, may be of or include ceramic frit in certain example embodiments, and/or may be lead-free or substantially lead-free (e.g., no more than about 15 ppm Pb, more preferably no more than about 5 ppm Pb, even more preferably no more than about 2 ppm Pb) in certain example embodiments. In certain example embodiments, each primer layer 31 and 32 may be of a material having a coefficient of thermal expansion (CTE) that is between that of the main seal layer 30 and the closest glass substrate 1, 2. For example, referring to FIGS. 1-4, primer layers 31 and 32 may each have a CTE (e.g., from about 8.0 to 8.8×10⁻⁶ mm/(mm*deg. C.), more preferably from about 8.3 to 8.6×10⁻⁶ mm/(mm*deg. C.)) which is between a CTE (e.g., from about 8.7 to 9.3×10⁻⁶ mm/(mm*deg. C.), more preferably from about 8.8 to 9.2×10⁻⁶ mm/(mm*deg. C.)) of the adjacent float glass substrate 1 and a CTE (e.g., from about 7.0 to 7.9×10⁻⁶ mm/(mm*deg. C.), more preferably from about 7.2 to 7.9×10⁻⁶ mm/(mm*deg. C.), with an example being about 7.6×10⁻⁶ mm/(mm*deg. C.)) of the main seal layer 30. The main seal layer 30 may have a CTE of at least 15% less than CTE(s) of the glass substrate(s) 1 and/or 2 in certain example embodiments. Thus, the multi-layer edge seal 3, via primer(s) 31 and/or 32, may provide for a graded CTE from the main seal 30 moving toward each glass substrate 1, 2, which provides for improved bonding of the edge seal to the glass and a more durable resulting vacuum insulating panel 100 such as capable of surviving exposure to asymmetric thermal loading and/or wind loads in the end application. The main seal layer 30, in certain example embodiments, need not contain significant amounts of CTE filler material (although it may contain significant amounts of filler in other example embodiments), which can result in an improved hermetic edge seal 3 and durability. A primer(s) 31 and/or 32 may be omitted in certain example embodiments. In certain example embodiments, primer layers 31 and 32 may be of or include different material(s) compared to the main seal layer 30.

In certain example embodiments, before and/or after sintering/firing, one or both primer layer(s) 31 and/or 32 may have a melting point (Tm) higher than the melting point of the main seal layer 30. For example, in certain example embodiments, one or both primer layers 31 and/or 32 may have a melting point (Tm) of from about 500-750 degrees C. (more preferably from about 575-680 degrees C., and most preferably from about 600-650 degrees C.), whereas the main seal layer 30 may have a lower melting point (Tm) of from about 300 to 450 degrees C. (more preferably from about 350-430 degrees C., and most preferably from about 380-420 degrees C. or from about 390-410 degrees C.). In certain example embodiments, one or both of the primer layers 31 and/or 32 may have a melting point (Tm) at least 100 degrees C. higher, more preferably at least 150 degrees C. higher, and most preferably at least 200 degrees C. higher, than the melting point of the main seal material 30. For purposes of example, in an example embodiment the main seal layer 30 may have a melting point of from about 390-410 degrees C. or from about 390-395 degrees C., whereas the primer layers 31 and 32 may each have a melting point of from about 585-625 degrees C. or from about 610-625 degrees C. In certain example embodiments, before and/or after sintering/firing, one or both primer layer(s) 31 and/or 32 may have a transition point (Tg) higher than the transition point of the main seal layer 30. For example, in certain example embodiments, before and/or after sintering/firing, one or both primer layer(s) 31 and/or 32 may have a transition point of from about 400-600 degrees C. (more preferably from about 425-550 degrees C., and most preferably from about 450 to 510 degrees C.), whereas the main seal layer 30 may have a lower transition point of from about 200 to 350 degrees C. (more preferably from about 230-330 degrees C., and most preferably from about 260 to 310 degrees C.). In a similar manner, in certain example embodiments, before and/or after sintering/firing, one or both primer layer(s) 31 and/or 32 may have a softening point (Ts) higher than the softening point of the main seal layer 30. For example, in certain example embodiments, one or both primer layer(s) 31 and/or 32 may have a softening point of from about 425-650 degrees C. (more preferably from about 475-620 degrees C., and most preferably from about 520 to 590 degrees C.), whereas the main seal layer 30 may have a lower softening point of from about 220 to 410 degrees C. (more preferably from about 270-380 degrees C., and most preferably from about 300 to 340 degrees C.). In certain example embodiments, before and/or after sintering/firing, one or both of the primer layer(s) 31 and/or 32 may have a softening point (Ts) at least 100 degrees C. higher, more preferably at least about 150 degrees C. higher, and most preferably at least about 150 or 200 degrees C. higher, than the softening point (Ts) of the main seal layer material 30. For purposes of example, in an example embodiment the main seal layer 30 may have a softening point of from about 310-330 degrees C., whereas the primer layers 31 and 32 may each have a softening point of from about 540-560 degrees C. For purposes of example, in an example embodiment the main seal layer 30 may have a melting point of from about 390-395 degrees C., whereas the primer layers 31 and 32 may each have a melting point of from about 610-625 degrees C. These feature(s) advantageously may allow each high melting point primer layers 31 and 32 to provide strong mechanical bonding with the supporting glass substrate (1 and/or 2) via sintering/firing in a first bulk heating step in an oven or other heater (e.g., heating above the melting point and/or softening point of the primer(s) while thermally tempering the glass substrate 1, 2 on which the primer is provided), and thereafter sintering/firing the lower melting point main seal material 30 in a different second heating step (e.g., via laser) to bond the main seal layer 30 to the previously sintered/fired primers 31 and 32 and form the edge seal 3 without significantly de-tempering the glass substrates. Thus, the main seal layer 30 and primers 31 and 32 can be sintered/fired in different heating steps, in a manner which allows thermal tempering of the glass substrates 1 and 2 when sintering/heating the primers on the respective glass substrates, and which allows the main seal layer 30 to thereafter be sintered and bonded to the primers 31 and 32 without significantly de-tempering the glass substrates 1 and 2. This advantageously results in more efficient processing, reduction in damage (e.g., micro-cracking, adhesive failure, cohesive failure, and/or significant de-tempering), and a more durable and longer lasting vacuum insulating panel with much of its temper strength retained allowing for example compliance with industry safety testing for bag impact and/or point impact fragmentation.

The edge seal 3, in certain example embodiments, may be located at an edge-deleted area (where the solar control coating 7 has been removed) of the substrate as shown in FIGS. 1-6. Thus, the edge seal 3 may be positioned so that it does not overlap the low-E coating 7 in certain example embodiments. The edge seal 3 may be located at the absolute edge of the panel 100 (e.g., FIG. 1), or may be spaced inwardly from the absolute edge of the panel 100 as shown in FIGS. 2-7 and 9, in different example embodiments. An outer edge of the hermetic edge seal 3 may be located within about 50 mm, more preferably within about 25 mm, and more preferably within about 15 mm, of an outer edge of at least one of the substrates 1 and/or 2. Thus, an “edge” seal does not necessarily mean that the edge seal 3 is located at the absolute edge or absolute periphery of a substrate(s) or overall panel 100.

The low-E coating 7 may be edge deleted around the periphery of the entire unit so as to remove the low-e coating material from the coated glass substrate. The low-E coating 7 edge deletion width (edge of glass to edge of low-E coating 7), in certain example embodiments, in at least one area may be from about 0-100 mm, with examples being no greater than about 6 mm, no greater than about 10 mm, no greater than about 13 mm, no greater than about 25 mm, with an example being about 16 mm. In certain example embodiments, there may be a gap between the primer seal layers 31 and 32 and/or main layer 30, and the low-E coating 7, of at least about 0.5 mm, more preferably a gap of at least about 1.0 mm, and for example a gap of at least about 5 mm so that the low-E coating 7 is not contiguous with the main seal layer 30 and/or the primer seal layers 31 and 32.

In certain example embodiments and referring to FIGS. 1-7 and 9 for example, in the manufactured vacuum insulating panel 100, the main seal layer 30 of the edge seal 3 may have an average width W of from about 2-20 mm, more preferably from about 4-10 mm, more preferably from about 3-9 mm or from about 4-8 mm, still more preferably from about 5-7 mm, and with an example main seal layer 30 average width being about 6 mm; and/or one or both of the primer layers 31 and 32 may have an average width Wp of from about 2-20 mm, more preferably from about 6-14 mm, more preferably from about 8-12 mm, still more preferably from about 9-11 mm, and with an example primer average width being about 10 mm. In certain example embodiments, the respective width(s) of each layer 30, 31, and 32 may be substantially the same (the same plus/minus 10%, more preferably plus/minus 5%) along the length of the edge seal 3 around the periphery of the entire panel 100. In certain example embodiments, the ratio Wp/W of the width Wp of one or both primer layers 31, 32 to the width W of the main seal layer 30 may be from about 1.2 to 2.2, more preferably from about 1.4 to 1.9, and most preferably from about 1.5 to 1.8 (e.g., the ratio Wp/W is 1.67 when a primer layer 31 and/or 32 is 10 mm wide and the main seal layer 30 is 6 mm wide: 10/6=1.67). In certain example embodiments, one or both primer layers 31 and/or 32 is/are at least about 1 mm wider, more preferably at least about 2 mm wider, and most preferably at least about 3 mm wider, than the main seal layer 30 at one or more locations around the periphery of the panel 100 and possibly around the entire periphery of the panel. These desirable widths for ceramic seal layers 30-32 in the panel 100 may be appropriate when using the materials for seal layers 30-32 discussed herein (e.g., see FIGS. 11-14), and may be adjusted in an appropriate manner if different seal materials are instead used which is possible in certain example embodiments. Other widths for one or more of seal layers 30-32, not discussed herein, may be used in various other example embodiments.

In certain example embodiments, as viewed from above and/or in cross-section as shown in FIG. 9 for example, the lateral edge(s) 30a and/or 30b of the main seal layer 30 may be spaced inwardly an offset distance “D” from the respective lateral edges of the primer seal layer 31 and/or the primer seal layer 32 on each side of the main seal layer. In certain example embodiments, the offset distance “D” on one or both sides of the main seal layer 30 may be from about 0.5 to 6.0 mm, more preferably from about 0.5 to 3.0 mm, more preferably from about 0.5 to 2.5 mm, more preferably from about 1.0 to 2.5 mm, and most preferably from about 1.5 to 2.5 mm, with an example being about 2.0 mm on each side, although the offset distance “D” may be different on the left and right sides of the main seal layer as viewed in FIG. 9 for example. In certain example embodiments, the offset distance “D” on one or both sides of the main seal layer 30 may be at least about 0.5 mm, more preferably at least about 1.0 mm, and most preferably at least about 1.5 mm, as shown in FIG. 9 for example. See also FIGS. 2, 4 and 6.

The multi-layer edge/perimeter seal 3 stack may be designed regarding one or more of moisture vapor transmission rate, hydrogen transmission rate, oxygen transmission rate, mechanical strength, thermal expansion, thermal diffusivity (TD), and/or thermal conductivity (TC). For example, the main seal layer 30 may be narrower in width than at least one primer to reduce thermal conductance between the opposing substrates. For example, thermal conductivity of soda lime silicate float glass (e.g., which may be used for one or more of the substrates 1, 2) may be about 1.11 W/mK. In certain example embodiments, layer 30 may have a lower thermal conductivity than traditional amorphous glass materials, e.g., 0.88 W/mK versus 1.10 W/mK. In certain example embodiments, one or both of the ceramic sealing primer layers 31-32 of the edge seal 3 may have a thermal conductivity(ies) of from about 1.00 to 1.90, or from about 1.40 W/mK to 1.80 W/mK, with an example being about 1.60 W/mK, which may be higher than the thermal conductivity of the glass substrates 1 and 2. Certain example embodiments may provide a ratio: TCml<TCg<TCpl, where TCml is the thermal conductivity of the main seal layer 30, TCg is the thermal conductivity of one or more of the glass substrates 1 and/or 2, and TCpl is the thermal conductivity of one or both primer layers 31 and/or 32. This ratio arrangement may advantageously improve the end of glass U-factor when reducing width(s) of a seal layer(s) (e.g., compared to a traditional 12 mm width), so as to optimize the volumetric amount(s) of one or more of the edge seal layer(s) for improving the overall U-factor of the glazing.

In certain example embodiments and referring to FIGS. 1-7 and 9 for example, in the manufactured vacuum insulating panel 100, the main seal layer 30 of the edge seal 3 may have an average thickness of from about 30-120 μm, more preferably from about 40-100 μm, and most preferably from about 50-85 μm, with an example main seal layer 30 average thickness being from about 60-80 μm as shown in FIG. 9. In certain example embodiments, in the manufactured vacuum insulating panel 100, the primer layer 31 of the edge seal 3 may have an average thickness of from about 10-80 μm, more preferably from about 20-70 μm, and most preferably from about 20-55 μm, with an example primer layer 31 average thickness being about 45 μm as shown in FIG. 9. In certain example embodiments, in the manufactured vacuum insulating panel 100, the primer layer 32 (opposite the side from which the laser beam 40 is directed) of the edge seal 3 may have an average thickness of from about 100-220 μm, more preferably from about 120-200 μm, and most preferably from about 120-170 μm, with an example primer layer 32 average thickness being about 145 μm as shown in FIG. 9. In certain example embodiments, the thickness of the main seal layer 30 may be at least about 30 μm thinner (more preferably at least about 45 μm thinner) than the thickness of the primer seal layer 32, and may be at least about 10 μm thicker (more preferably at least about 20 μm, and more preferably at least about 30 μm thicker) than the thickness of the primer seal layer 31. In certain example embodiments, in the manufactured vacuum insulating panel 100, the overall average thickness of the edge seal 3 may be from about 150-330 μm, more preferably from about 200-310 μm, and most preferably from about 240-290 μm, with an example overall edge seal 3 average thickness being about 270 μm as shown in FIG. 9. In certain example embodiments, the respective thicknesses of each layer 30, 31, and 32 are substantially the same (the same plus/minus 10%, more preferably plus/minus 5%) along the length of the edge seal 3 around the periphery of the entire panel 100.

In certain example embodiments, in the manufactured vacuum insulating panel 100, the ratio T_{M}/T_{P1} of the thickness T_{M} of the main seal layer 30 to the thickness T_{P1} of thin primer layer 31 may be from about 1.2 to 2.2, more preferably from about 1.4 to 2.0, and most preferably from about 1.5 to 1.9 (e.g., the ratio T_{M}/T_{P1} is 1.78 when a primer layer 31 is 45 μm thick and the main seal layer 30 is 80 μm thick as shown in FIG. 9: 80/45=1.78). In certain example embodiments, in the manufactured vacuum insulating panel 100, the ratio T_{M}/T_{P2} of the thickness T_{M} of the main seal layer 30 to the thickness T_{P2} of the primer layer 32 may be from about 0.25 to 0.90, more preferably from about 0.40 to 0.75, and most preferably from about 0.45 to 0.65 (e.g., the ratio T_{M}/T_{P2} is 0.55 when a primer layer 32 is 145 μm thick and the main seal layer 30 is 80 μm thick as shown in FIG. 9: 80/145=0.55). In certain example embodiments, in the manufactured vacuum insulating panel 100, the ratio T_{M}/T_{S} of the thickness T_{M} of the main seal layer 30 to the total thickness Ts of the overall edge seal 3 may be from about 0.15 to 0.60, more preferably from about 0.20 to 0.50, and most preferably from about 0.25 to 0.35 (e.g., the ratio T_{M}/T_{S} is 0.30 when the overall seal 3 is 270 μm thick and the main seal layer 30 is 80 μm thick as shown in FIG. 9: 80/270=0.30). These thicknesses for ceramic seal layers 30-32 in the panel 100 may be appropriate when using the materials for seal layers 30-32 discussed herein (e.g., see FIGS. 11-14), and may be adjusted in an appropriate manner such as if different seal materials are instead used which is possible in certain example embodiments. Other thicknesses for layers 30-32, not discussed herein, may be used in various other example embodiments.

The primer layer 31 and/or main seal layer 30 may be designed and optimized to have a high thermal diffusivity to transfer heat from the laser source through the primer layer 31 and main seal layer 30 to fully sinter the main sealing layer 30 and wet the interfaces between the main layer 30 and opposing primer layers 31-32.

In various example embodiments, laser 41 may be selected to emit a laser beam 40 having a wavelength (λ) of from about 500 nm to 1064 nm, more preferably from about 780-1064 nm. Laser 41 may be a near IR laser in certain example embodiments. Laser 41 may be a continuous wave laser, a pulsed laser, and/or other suitable laser in various example embodiments. In various example embodiments, the laser 41 may be a scanning laser system comprising diode, ND:YAG, CO₂ and/or other laser devices/sources. In certain example embodiments, laser 41 may emit a laser beam 40 at or having a wavelength of about 532 nm, 546 nm, 564 nm, 800 nm, 808 nm, 810 nm, 940 nm, or 1090 nm (e.g., YVO4 laser). In certain example embodiments, more than one laser may be utilized to increase the sealing speed, lower effective laser power levels and/or reduce laser spot size. Two lasers operating in a serial, overlapping manner can increase the effective irradiation spot time to achieve for example 0.5 seconds while achieving for example a 20 mm per second linear laser rate, as an example. Two 9-mm laser diameter beams 40, for example, can operate in a serial fashion for a 0.5 second to 1.0 second irradiation time.

FIGS. 11-12 and 14 illustrate an example material(s) that may be used for the main seal layer 30 in various example embodiments, including for example in any of the embodiments of FIGS. 1-9. However, other suitable materials (vanadium oxide based ceramic materials with little or no Te oxide, solder glass, or the like) may instead be used for layer 30 in various example embodiments. FIG. 11 is a table/graph showing weight % and mol % of various compounds/elements in an example main seal 30 material, prior to sintering of layer 30, according to an example embodiment (measured via non-carbon detecting XRF); FIG. 12 is a table/graph showing weight % and mol % of various compounds/elements in an example main seal 30 material according to an example embodiment (measured via carbon detecting XRF), before and after laser treatment/sintering of the main seal layer 30 for edge seal formation; and the left side of FIG. 14 sets forth a table/graph showing an elemental analysis (non-oxide analysis) of weight % and mol % of various elements in an example main seal 30 material, before and after laser treatment for edge seal formation. Regarding FIG. 14, X-ray Fluorescence (XRF) is a non-destructive technique that can identify and quantify the elemental constituents of a sample using the secondary fluorescence signal produced by irradiation with high energy x-rays, and wavelength dispersive spectrometer (WDXRF) is capable of detecting elements from atomic number (Z) 4 (beryllium) through atomic number 92 (uranium) at concentrations from the low parts per million (ppm) range up to 100% by weight.

Other compounds may also be provided in this main seal 30 material, including but not limited to, on a weight and/or mol basis, for example one or more of: 0-15% (more preferably 1-10%) tungsten oxide; 0-15% (more preferably 1-10%) molybdenum oxide; 0-60% (or 38-52%) zinc oxide; 0-15% (more preferably 0-10%, more preferably from about 2-10%, more preferably from about 4-8%) copper oxide, and/or other elements shown in the figures. For example, a thermal diffusivity/conductivity additive such as metallic copper or copper oxide (e.g., CuOₓ, where x may be from about 0.2 to 1.5, more preferably from about 0.5 to 1.4, more preferably from about 0.8 to 1.2, more preferably from about 0.9 to 1.1, with an example being about 1.0) may be added to the material for main seal layer 30 in order to increase thermal diffusivity and/or absorption of the main seal material so that it can be laser sintered more quickly and/or more efficiently in the manufacturing process.

This ceramic tellurium (Te) oxide based main seal material, shown in FIGS. 11-12 and 14, was used for main seal layer 30 in examples tested for obtaining data herein for various figures/tables unless otherwise specified. This ceramic tellurium (Te) oxide based main seal material, shown in FIGS. 11-12 and 14, for example may be considered to have a melting point (Tm) of approximately 390 or 395 degrees C., a softening point (Ts) of 320 degrees C., and a glass transition point (Tg) of approximately 290 degrees C.

Table 1A sets forth example ranges for various elements and/or compounds for this example tellurium (Te) oxide based main seal 30 material according to various example embodiments, for both mol % and weight %, prior to firing/sintering thereof and thus prior to hermetic edge seal 3 formation. In certain example embodiments, the main seal layer 30 may comprise mol % and/or wt. % of the following compounds in one or more of the following orders of magnitude: tellurium oxide>vanadium oxide>aluminum oxide, tellurium oxide>vanadium oxide>silicon oxide, tellurium oxide>vanadium oxide>aluminum oxide>magnesium oxide, and/or tellurium oxide>vanadium oxide>silicon oxide>magnesium oxide, before and/or after firing/sintering of the layer 30. It will be appreciated that other materials may be used together, or in place of, those shown below, and that the example percentages may be different in alternate embodiments.

TABLE 1A
(example material for main seal layer 30 prior to firing/sintering)

| | | More | Most | | More | Most |
|---|---|---|---|---|---|---|
| | General | Preferred | Preferred | General | Preferred | Preferred |
| | (Mol %) | (Mol %) | (Mol %) | (Wt. %) | (Wt. %) | (Wt. %) |
| Tellurium oxide | 20-60% or | 25-50% or | 30-42% | 20-70% | 30-65% | 40-55% |
| (e.g., TeO₄ and/or | 40-90% | 40-70% | | | | |
| other stoichiometry) | | | | | | |
| Vanadium oxide | 5-45% or | 10-30% or | 15-21% | 5-50% | 8-38% | 18-28% |
| (e.g., VO₂ and/or | 5-58% | 5-37% | | | | |
| other stoichiometry) | | | | | | |
| Aluminum oxide | 0-45% or | 5-30% or | 10-20% | 0-45% | 5-30% | 10-20% |
| (e.g., Al₂O₃ and/or | 1-25% | 6-25% | | | | |
| other stoichiometry) | | | | | | |
| Silicon oxide | 0-50% or | 10-30% | 15-25% | 0-50% | 3-30% | 5-20% |
| (e.g., SiO₂ and/or | 0-5% | | | | | |
| other stoichiometry) | | | | | | |
| Magnesium oxide | 0-50% or | 3-30% | 5-15% | 0-50% | 1-12% | 2-7% |
| (e.g., MgO and/or | 0-10% | | | | | |
| other stoichiometry) | | | | | | |
| Barium oxide | 0-20% | 0-10% | 0.10-5% | 0-20% | 0-10% | 0.10-5% |
| (e.g., BaO and/or | | | | | | |
| other stoichiometry) | | | | | | |
| Manganese oxide | 0-20% | 0-10% | 0.50-5% | 0-20% | 0-10% | 0.50-5% |
| (e.g., MnO and/or | | | | | | |
| other stoichiometry) | | | | | | |
| Copper oxide | 0.1-20% | 1-15% | 2-10% or | 0.1-14% | 0.7-10% | 1.3-7% or |
| (e.g., CuO or | | | 2-5% | | | 2-5% |
| other stoichiometry) | | | | | | |

Tellurium Vanadate based and/or inclusive glasses (including tellurium oxide and vanadium oxide), such as those in Table 1A, in certain example embodiments are ideally suited for the main seal functionality when utilizing laser irradiation for the firing/sintering of the main seal layer 30. The base main seal material may comprise tellurium oxide (e.g., a combination of TeO₃, TeO₃₊₁, and TeO₄) and vanadium oxide (e.g., a combination of V₂O₅, VO₂, and V₂O₃), and/or a thermal diffusivity/conductivity additive such as copper oxide, per the weight % and/or mol % described in Tables 1A-1C. In certain example embodiments, it may be desirable to have a higher amount of tellurium oxide compared to vanadium oxide, in order to increase the material density in the sintered state and thus improve hermiticity of the seal. With respect to main seal material(s) in Table 1A for the main seal layer 30, the Te oxide (e.g., one or more of TeO₄, TeO₃, TeO₃₊₁, and/or other stoichiometry (ies) involving Te and O) and V oxide (e.g., one or more of VO₂, V₂O₅, V₂O₃, and/or other stoichiometry (ies) involving V and O) in the material may be made up of about the following stoichiometries before/after sintering as shown below in Table 1B (tellurium oxide stoichiometries prior to firing/sintering), Table 1C (tellurium oxide stoichiometries after firing/sintering), Table 1D (vanadium oxide stoichiometries prior to firing/sintering), Table 1E (vanadium oxide stoichiometries after firing/sintering), respectively, measured via XPS.

TABLE 1B
(example stoichiometries of Te oxide in material for
main seal layer 30 prior to laser firing/sintering)

| | | More | Most | |
|---|---|---|---|---|
| | General | Preferred | Preferred | Example |
| TeO₄ | 35-85% | 45-70% | 55-60% | 57% |
| TeO₃ | 20-65% | 30-55% | 35-45% | 42% |
| TeO₃₊₁ | 0-15% | 0.2-7% | 0.5-3% | 1% |

TABLE 1C
(example stoichiometries of Te oxide in material for
main seal layer 30 after laser firing/sintering)

| | | More | Most | |
|---|---|---|---|---|
| | General | Preferred | Preferred | Example |
| TeO₄ | 3-35% | 5-25% | 10-20% | 14% |
| TeO₃ | 60-95% or | 70-90% | 78-85% | 81% |
| | 50-95% | | | |
| TeO₃₊₁ | 0-15% | 1-9% | 3-7% | 5% |

TABLE 1D
(example stoichiometries of V oxide in material for
main seal layer 30 prior to laser firing/sintering)

| | | More | Most | |
|---|---|---|---|---|
| | General | Preferred | Preferred | Example |
| V₂O₅ | 50-97% | 70-95% | 80-90% | 84% |
| VO₂ | 5-35% | 10-20% | 12-18% | 15% |
| V₂O₃ | 0-15% | 0.2-7% | 0.5-3% | 1% |

TABLE 1E
(example stoichiometries of V oxide in material for
main seal layer 30 after laser firing/sintering)

| | | More | Most | |
|---|---|---|---|---|
| | General | Preferred | Preferred | Example |
| V₂O₅ | 5-45% | 10-35% | 20-30% | 25% |
| VO₂ | 35-85% | 50-75% | 58-67% | 63% |
| V₂O₃ | 2-30% | 6-20% | 9-15% | 12% |

For example, the “Example” column in Table 1B indicates that 57% of the Te present in the material prior to sintering/firing was in an oxidation state of TeO₄, 42% of the Te present in the material prior to sintering/firing was in an oxidation state of TeO₃, and 1% of the Te present in the material prior to sintering/firing was in an oxidation state of TeO₃₊₁. And the “Example” column in Table 1C indicates that after the laser firing/sintering of the main seal layer 30 just 14% of the Te present in the main seal layer 30 material was in an oxidation state of TeO₄, but 81% of the Te present in the material was in an oxidation state of TeO₃, and 5% of the Te present in the material prior to sintering/firing was in an oxidation state of TeO₃₊₁. Accordingly, in certain example embodiments, it will be appreciated that the laser firing/sintering of the main seal layer 30 may cause much of the TeO₄ to transform/convert into TeO₃ and TeO₃₊₁, which is advantageous because it increases the material's absorption in the near infrared (e.g., 808 or 810 nm for example, which may be used for the laser during sintering/firing) which provides for increased heating efficiency and reducing the chances of significantly de-tempering the glass substrate(s) due to improved heating efficiency during the firing/sintering.

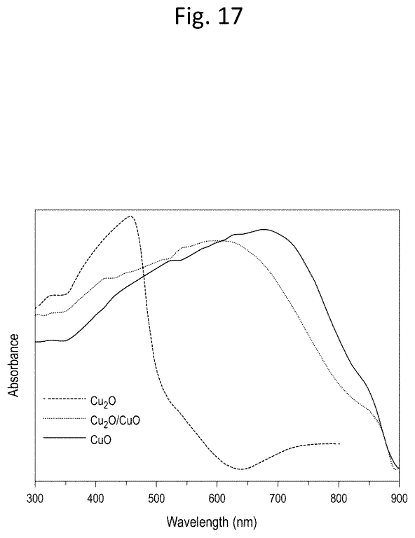

Regarding Tables 1B-1C, FIG. 30 is a Binding Energy (eV) vs. Intensity graph illustrating the shift in binding energy for Te in the main seal layer 30 caused by laser sintering/firing thereof according to an example embodiment. It can be seen that the laser sintering/firing led to a distinct shift in binding energy associated with Te in main seal layer 30. A binding energy shift toward depolymerized tellurite structures. The laser sintering/firing of the main seal layer 30 also caused the binding energy peak for V to shift in a distinct manner, corresponding to a reduction of V⁵⁺ to V⁴⁺/V³⁺ in the main seal layer 30. For example, in certain example embodiments, the laser sintering/firing of the main seal layer 30 may cause at least one of in the main seal layer 30: (a) a binding energy shift of the Te peak of at least about 0.15 eV, more preferably of at least about 0.20 eV, and most preferably of at least about 0.25 or 0.30 eV, which resulted in the stoichiometry changes discussed in Tables 1B-1C and the related advantages discussed above, and/or (b) a binding energy shift of the V peak of at least about 0.10 eV, more preferably of at least about 0.15 eV, which resulted in the stoichiometry changes discussed in Tables 1D-1E and the related advantages discussed above. In contrast, in certain example embodiments, the laser sintering/firing of the preform seal 13 for the pump-out tube seal did not result in a distinct binding energy shift of the Te peak or the V peak for preform 13, demonstrating that not all laser sintering/firing techniques have such an effect.

In certain example embodiments, prior to firing/sintering, the material for the main seal layer 30 may include tellurium oxide with the following stoichiometry/oxidation state ratio(s) in terms of what oxidation state(s) are used by the Te in the material (e.g., see Table 1B): TeO₄>TeO₃>TeO₃₊₁. But the laser sintering/firing of the main seal layer may then cause the Te stoichiometry ratios/states to change to the following during/after sintering/firing: TeO₃>TeO₄>TeO₃₊₁, which is advantageous in vacuum insulating panels as discussed above. The TeO₄ is a trigonal bipyramid structure, TeO₃ is a trigonal pyramid structure, and TeO₃₊₁ is a polyhedral structure. In certain example embodiments, due to optimized laser treatment for firing/sintering of the main seal layer as discussed herein, the TeO₄ largely converts to TeO₃ and marginally to TeO₃₊₁ with increasing temperature with a concurrent increase in the number of Te═O sites resulting from cleavage within the network structure. Tellurium oxide may have, for example, a Tg of about 305 degrees C., a crystallization temperature (Tx) of about 348 degrees C., and a Tm about 733 degrees C.

For example, the “Example” column in Table 1D indicates that 84% of the V present in the material prior to sintering/firing was in an oxidation state of V₂O₅, 15% of the V present in the material prior to sintering/firing was in an oxidation state of VO₂, and 1% of the V present in the material prior to sintering/firing was in an oxidation state of V₂O₃. And the “Example” column in Table 1E indicates that after the laser firing/sintering of the main seal layer just 25% of the V present in the main seal layer 30 material was in an oxidation state of V₂O₅, but 63% of the V present in the material was in an oxidation state of VO₂, and 12% of the V present in the material prior to sintering/firing was in an oxidation state of V₂O₃. The other columns in Tables 1B-1E represent the same, with different values as shown. Accordingly, in certain example embodiments, it will be appreciated that the laser firing/sintering of the main seal layer 30 may cause much of the V₂O₅ to transform/convert into VO₂ and V₂O₃, which is advantageous because it increases the material's density and thus the hermiticity and durability of the seal (e.g., VO₂ results in a more dense layer than does V₂O₅). In certain example embodiments, it is desirable to reduce the V₂O₅ content in the final sintered/fired state of the main seal 30 because the glass network becomes more closed with decreasing V₂O₅ concentration, e.g., due to the reduction of non-bridging oxygen resulting in a higher density seal which improves water/moisture resistance, mechanical strength (adhesive and cohesive), and/or hermeticity. The Tg of the main seal 30 material may also slightly increase with a reduction in V₂O₅.

In certain example embodiments, the vanadium oxide in the main seal layer material, before firing/sintering of the main seal layer 30, may include the following stoichiometry/oxidation state ratio(s): V₂O₅>VO₂>V₂O₃. But the laser sintering/firing of the main seal layer 30 may then cause the V stoichiometry ratios/states to change to the following during/after sintering/firing: VO₂>V₂O₅>V₂O₃, which is advantageous in vacuum insulating panels as discussed at least because it allows for higher density in the final seal layer. The V₂O₅ is an orthorhombic structure, VO₂ is a tetragonal structure, and V₂O₃ is corundum structured in the monoclinic C2/c space group. Vanadium is an insulator in a base form due to empty d-bands and acts as a network former/network modifier in the presence of tellurium oxide in the main seal material for layer 30 and/or the pump-out tube seal in certain example embodiments. Vanadium oxide may have, for example, a Tg about 250 degrees C., a crystallization temperature (Tx) about 300 degrees C., and a Tm about 690 degrees C.

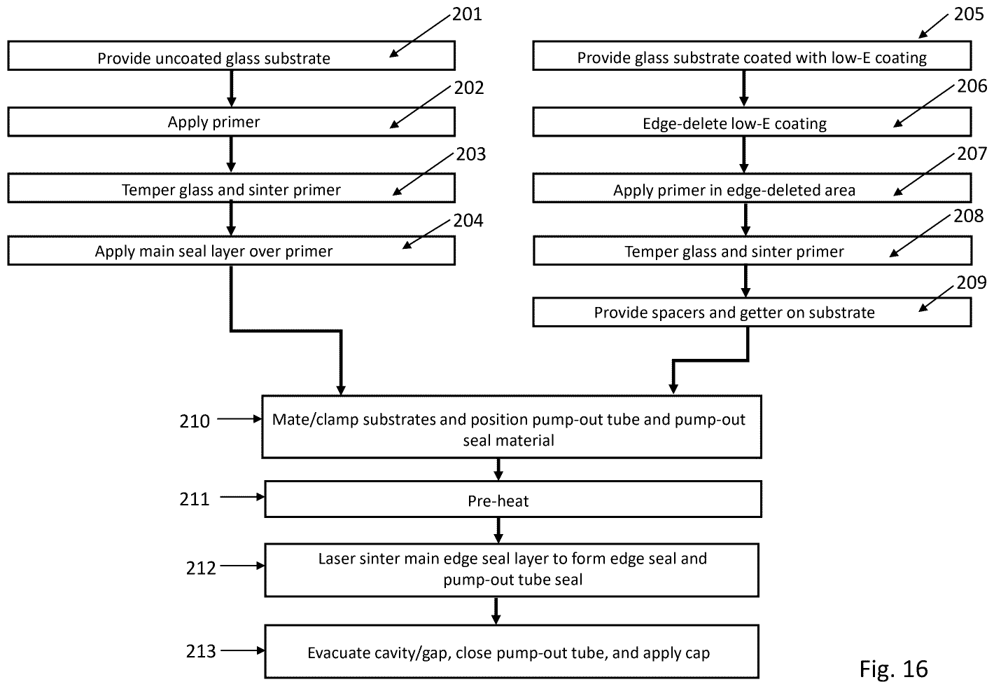

Thus, from Tables 1B-1E, FIG. 12, and FIG. 30, it will be appreciated that in certain example embodiments an optimized type of laser processing (e.g., 808 or 810 nm continuous wave laser using the process in FIG. 22 and a laser beam size of about 6 mm, following a pre-heat to about 300-320 degrees C.) may be used to sinter/fire the main seal layer 30 in a manner that causes one or more, or any combination, of the following to occur during and/or as a result of the sintering/firing: (a) stoichiometry values/oxidation states of Te in the layer to change from TeO₄>TeO₃>TeO₃₊₁ prior to laser firing/sintering, to TeO₃>TeO₄>TeO₃₊₁ following laser firing/sintering of the layer 30; (b) stoichiometry values/oxidation states of Te in the layer to change from TeO₄>TeO₃ prior to laser firing/sintering, to TeO₃>TeO₄ following laser firing/sintering of the layer 30; (c) stoichiometry values/oxidation states of vanadium (V) in the layer to change from V₂O₅>VO₂>V₂O₃ prior to laser firing/sintering, to VO₂>V₂O₅>V₂O₃ after laser firing/sintering of the layer 30; (d) stoichiometry values/oxidation states of V in the layer to change from V₂O₅>VO₂ prior to laser firing/sintering, to VO₂>V₂O₅ after laser firing/sintering of the layer 30; (e) the ratio TeO₄:TeO₃ to change from about 1.0 to 2.0 (more preferably from about 1.2 to 1.6, more preferably from about 1.3 to 1.5) prior to sintering/firing to from about 0.05 to 0.40 (more preferably from about 0.10 to 0.30, more preferably from about 0.13 to 0.22) after the laser sintering/firing of the layer 30; (f) the ratio V₂O₅:VO₂ to change from about 1.0 to 10.0 (more preferably from about 3.0 to 8.0, more preferably from about 4.5 to 7.0, with an example being 84:15=5.66) prior to sintering/firing to from about 0.10 to 0.90 (more preferably from about 0.20 to 0.80, more preferably from about 0.25 to 0.50, with an example being 25:63=0.39) after the laser sintering/firing of the layer 30; (g) a binding energy shift of the Te peak of at least about 0.15 eV, more preferably of at least about 0.20 eV, and most preferably of at least about 0.25 or 0.30 eV; and/or (h) a binding energy shift of the V peak of at least about 0.10 eV, more preferably of at least about 0.15 eV.

This main seal material(s) from Table 1 and FIGS. 11-12, 14, or substantially the same material, may also be used for the pump-out tube seal 13, with or without a primer, in certain example embodiments, although other types of seals may also be used such as vanadium oxide based ceramic sealing glass or solder glass.

Table 2 sets forth example ranges for various elements and/or compounds for this example tellurium oxide-based material for main seal layer 30 according to various example embodiments, for both mol % and weight %, after firing/sintering thereof and thus after hermetic edge seal 3 formation. It will be appreciated that other materials may be used together, or in place of, those shown below, and that the example percentages may be different in alternate embodiments.

TABLE 2
(example material for main seal layer 30 after laser firing/sintering)

| | | More | Most | | More | Most |
|---|---|---|---|---|---|---|
| | General | Preferred | Preferred | General | Preferred | Preferred |
| | (Mol %) | (Mol %) | (Mol %) | (Wt. %) | (Wt. %) | (Wt. %) |
| Tellurium oxide | 20-60% or | 40-70% | 50-60% | 20-80% | 40-70% | 50-65% |
| (e.g., TeO₃ and/or | 40-90% | | | | | |
| other stoichiometry) | | | | | | |
| Vanadium oxide | 5-45% or | 8-30% or | 20-25% | 10-50% | 12-40% | 25-30% |
| (e.g., VO₂ and/or | 5-58% | 5-37% | | | | |
| other stoichiometry) | | | | | | |
| Aluminum oxide | 0-45% or | 5-30% or | 8-20% | 0-45% | 3-30% | 5-15% |
| (e.g., Al₂O₃ and/or | 1-25% | 6-25% | | | | |
| other stoichiometry) | | | | | | |
| Silicon oxide | 0-50% or | 3-30% | 5-20% | 0-50% | 1-25% | 1-10% |
| (e.g., SiO₂ and/or | 0-5% | | | | | |
| other stoichiometry) | | | | | | |
| Magnesium oxide | 0-50% or | 0.1-20% | 0.5-5% | 0-50% | 0.1-12% | 0.2-5% |
| (e.g., MgO and/or | 0-10% | | | | | |
| other stoichiometry) | | | | | | |
| Barium oxide | 0-20% | 0-10% | 0-5% | 0-20% | 0-10% | 0-5% |
| (e.g., BaO and/or | | | | | | |
| other stoichiometry) | | | | | | |
| Manganese oxide | 0-20% | 0-10% | 0.50-5% | 0-20% | 0-10% | 0.50-5% |
| (e.g., MnO and/or | | | | | | |
| other stoichiometry) | | | | | | |
| Copper oxide | 0.1-20% | 1-15% | 2-10% or | 0.1-14% | 0.7-10% | 1.3-7% or |
| (e.g., CuO or | | | 2-5% | | | 2-5% |
| other stoichiometry) | | | | | | |

This material from Tables 1-2 and FIGS. 11-12, 14 may also be used for the pump-out tube seal 13, with or without a primer, in certain example embodiments, although other types of seals may also be used such as vanadium oxide based ceramic sealing glass or solder glass. Other compounds may also be provided in or for this main seal 30 material, including but not limited to, on a weight or mol basis, for example one or more of: 0-15% (more preferably 1-10%) tungsten oxide; 0-15% (more preferably 1-10%) molybdenum oxide; 0-60% (or 38-52%) zinc oxide; 0-15% (more preferably 0-10%) copper oxide, and/or other elements shown in the figures. Certain elements may change during firing/sintering, and certain elements may at least partially burn off during processing prior to formation of the final edges seal 3.

In certain example embodiments, particle size for the material of the main seal layer 30 may be optimized for reduced particle size (e.g., for the D50 distribution) to improve material density and moisture resistance, and/or to improve thermal diffusivity. Traditional ceramic sealing glass materials have a D50 in the range of about 60.0 μm to about 90.0 μm which is acceptable for a thermal oven sintering process as an example, but has been found to experience some issues for laser processing. For laser processing, it has been found that improved results can be achieved by reducing particle size of the main seal layer 30. In certain example embodiments, the average D50 particle size and PSD mean may be significantly lower than traditional ceramic sealing glasses, as particle size is related to a thermal diffusivity rate of the ceramic sealing glass materials. Moreover, it has surprisingly been found that if the particle size is too large, then the density of the layer 30 tends to decrease and porosity tends to increase, and the layer becomes more susceptible to water and/or air leakage and seal failure. It has also been found that too large of a particle size may contribute to significant de-tempering of the glass during edge seal formation, e.g., due to increasing lasing temperature and/or duration. Thus, small particle size may be used for layer 30 (and one or more of layers 31-32) in certain example embodiments. In certain example embodiments, before and/or after edge seal formation, the main seal layer 30 may have an average particle/grain size (D50) of from about 1-25 μm, more preferably from about 1-20 μm, more preferably from about 3-20 μm, more preferably from about 5-20 μm, more preferably from about 5-15 μm, and most preferably from about 10-15 μm. In certain example embodiments, before and/or after edge seal formation, the main seal layer 30 may have an average particle/grain size (D50) of no greater than about 25 μm, more preferably no greater than about 20 μm, more preferably no greater than about 15 μm. These same particle sizes may also be used for one or both primer layers 31 and/or 32, and/or tube seal material 13, before and/or after firing/sintering.

In certain example embodiments, the material for the main seal layer 30 may include filler. The amount of filler may, for example, be from 1-25 wt. % and may have an average grain size (d50) of 5-30 μm, for example an average d50 grain size from about 5-20 μm, more preferably from about 5-15 μm, and most preferably less than about 10 μm. Mixtures of two or more grain size distributions (e.g., coarse: d50=15-25 μm and fine: d50=1-10 μm) may be used. The filler may, for example, comprise one or more of zirconyl phosphates, dizirconium diorthophosphates, zirconium tungstates, zirconium vanadates, aluminum phosphate, cordierite, eucryptite, ekanite, alkaline earth zirconium phosphates such as (Mg,Ca,Ba,Sr)Zr₄P₅O₂₄, either alone or in combination. Filler in a range of 20-25 wt. % may be used in layer 30 in certain example embodiments. Main seal layer 30, and/or the primer layer(s) 31 and/or 32, is/are lead-free and/or substantially lead-free in certain example embodiments.

Table 3 sets forth example ranges for various elements for this example tellurium oxide based main seal 30 material according to various example embodiments, using elemental analysis (non-oxide analysis) for both mol % and weight %, prior to firing/sintering thereof and thus prior to hermetic edge seal 3 formation. FIG. 14 also provides an elemental analysis for various example seal materials, including for Te oxide based main seal and/or pump-out tube seal layers 30 and 13. Thermal diffusivity/conductivity additive(s), such as copper/copper oxide, are not shown in Tables 3-4, but may be added to the material for the main seal layer 30 as discussed herein. In certain example embodiments, the main seal layer 30 and/or the pump-out seal layer 13 may comprise mol % and/or wt. % of the following elements in one or more of the following orders of magnitude: Te>V>Al, Te>V>Si, Te>V>Al>Mg, Te>O>V, Te>O>V>Al, and/or Te>V>Si>Mg, before and/or after firing/sintering of the layer (e.g., see also FIG. 14). It will be appreciated that other materials may be used together, or in place of, those shown below, and that the example percentages may be different in alternate embodiments. The elemental Te/V ratio in the main seal layer 30 and/or seal layer 13, after sintering/firing and in terms of weight %, may be from about 1.5:1 to 5:1, more preferably from about 2:1 to 4:1, and most preferably from about 2.5:1 to 3.5:1. The elemental Te/Al ratio in the main seal layer 30 and/or seal layer 13, after firing/sintering thereof and in terms of weight %, may be from about 5:1 to 35:1, more preferably from about 8:1 to 20:1, and most preferably from about 9:1 to 15:1. The elemental Si/Mg ratio in the main seal layer 30 and/or seal layer 13, after firing/sintering thereof and in terms of weight %, may be from about 1:1 to 35:1, more preferably from about 2:1 to 10:1, and most preferably from about 3:1 to 7:1. It has been found that one or more of these ratios is technically advantageous for achieving desirable melting points, softening points, and/or thermal diffusivity.

TABLE 3
(elemental analysis - example main seal
30 material prior to firing/sintering)

| | | More | Most | | More | Most |
|---|---|---|---|---|---|---|
| | | Pre- | Pre- | | Pre- | Pre- |
| | General | ferred | ferred | General | ferred | ferred |
| | (Mol | (Mol | (Mol | (Wt. | (Wt. | (Wt. |
| | %) | %) | %) | %) | %) | %) |
| Te | 5-40% | 8-25% | 10-20% | 20-70% | 30-60% | 40-50% |
| O | 30-75% | 40-70% | 50-60% | 10-40% | 15-35% | 20-30% |
| V | 3-30% | 5-15% | 7-13% | 5-40% | 10-25% | 12-17% |
| Al | 5-40% | 8-25% | 10-15% | 2-30% | 3-20% | 5-11% |
| Si | 2-30% | 3-15% | 5-10% | 1-20% | 2-10% | 3-7% |
| Mg | 0-15% | 1-7% | 1-5% | 20-70% | 30-60% | 40-50% |
| Mn | 0-20% | 0.1-5% | 0.5-2% | 0-20% | 0.1-5% | 0.5-2% |

This material may also be used for the pump-out seal 13, with or without a primer, in certain example embodiments, although other types of seals may also be used such as vanadium oxide based ceramic sealing glass or solder glass. Other compounds may also be provided in this material (e.g., see FIG. 14).

Table 4 sets forth example ranges for various elements for this example tellurium oxide based main seal 30 material according to various example embodiments, using elemental analysis (non-oxide analysis) for both mol % and weight %, after firing/sintering thereof and thus after formation of the hermetic edge seal 3 (e.g., see also FIG. 14). It will be appreciated that other materials may be used together, or in place of, those shown below, and that the example percentages may be different in alternate embodiments.

TABLE 4
(elemental analysis - example main seal 30 material after firing/sintering)

| | | More | Most | | More | Most |
|---|---|---|---|---|---|---|
| | | Pre- | Pre- | | Pre- | Pre- |
| | General | ferred | ferred | General | ferred | ferred |
| | (Mol | (Mol | (Mol | (Wt. | (Wt. | (Wt. |
| | %) | %) | %) | %) | %) | %) |
| Te | 10-60% | 20-40% | 25-30% | 20-90% | 40-80% | 50-70% |
| O | 20-60% | 25-50% | 30-40% | 3-22% | 5-16% | 7-12% |
| V | 3-30% | 5-15% | 7-13% | 5-40% | 10-25% | 12-17% |
| Al | 3-40% | 6-25% | 8-15% | 1-20% | 2-12% | 4-8% |
| Si | 0.5-10% | 1-6% | 2-4% | 0.5-10% | 1-6% | 1-3% |
| Mg | 0-10% | 0.1-5% | 0.5-3% | 0-10% | 0.01-5% | 0.1-3% |
| Mn | 0-20% | 0.5-6% | 1-3% | 0-20% | 0.5-6% | 1-3% |

This material may also be used for the pump-out seal 13, with or without a primer, in certain example embodiments, although other types of seals may also be used such as vanadium oxide based ceramic sealing glass or solder glass. Other compounds may also be provided in this material (e.g., see FIG. 14).

FIGS. 13-14 illustrate an example material(s) that may be used for the primer layer(s) 31 and/or 32 in various example embodiments, including for example in any of the embodiments of FIGS. 1-9. However, other suitable materials, such as solder glass, other materials comprising bismuth oxide, and so forth, may be used for one or both primer layers 31 and/or 32 in various example embodiments. FIG. 13 is a table/graph showing weight % and mol % of various compounds/elements in a primer seal 31 and/or 32 material according to an example embodiment (measured via carbon detecting XRF), before and after laser treatment for edge seal formation, which primer material may be used in combination with any embodiment herein (e.g., for one or both primer layers); and the right side of FIG. 14 sets forth a table/graph showing an elemental analysis (non-oxide analysis) of weight % and mol % of various elements in an example primer material, before and after laser treatment for edge seal formation. This primer material, shown in FIGS. 13-14, was used for primer layers 31 and 32 in examples tested for obtaining data herein for various figures/tables herein unless otherwise specified. This primer material, shown in FIGS. 13-14, for example may be considered to have a melting point (Tm) of 620 degrees C., a softening point (Ts) of 551 degrees C., and a glass transition point (Tg) of 486 degrees C.

Table 5 sets forth example ranges for various elements and/or compounds for this example primer material according to various example embodiments, for both mol % and weight %, prior to firing/sintering. In certain example embodiments, one or both of the primer layers 31 and/or 32 may comprise mol % and/or wt. % of the following compounds in one or more of the following orders of magnitude: boron oxide>bismuth oxide>silicon oxide, bismuth oxide>silicon oxide>boron, boron oxide>bismuth oxide>silicon oxide>titanium oxide, bismuth oxide>silicon oxide>boron oxide>titanium oxide, boron oxide>silicon oxide>titanium oxide>bismuth oxide, and/or silicon oxide>boron oxide>bismuth oxide, before and/or after formation of the hermetic edge seal 3. It will be appreciated that other materials may be used together, or in place of, those shown below, and that the example percentages may be different in alternate embodiments.

TABLE 5
(example primer material prior to firing/sintering)

| | | More | Most | | More | Most |
|---|---|---|---|---|---|---|
| | General | Preferred | Preferred | General | Preferred | Preferred |
| | (Mol %) | (Mol %) | (Mol %) | (Wt. %) | (Wt. %) | (Wt. %) |
| bismuth oxide | 0.5-50% | 1-10% | 2-5% | 5-50% or | 10-40% or | 15-25% or |
| (e.g., Bi₂O₃ and/or | | | | 55-95% | 70-80% | 70-80% |
| other stoichiometry) | | | | | | |
| boron oxide | 10-50% | 20-40% | 25-35% | 10-50% | 20-40% | 25-35% |
| (e.g., B₂O3 and/or | | | | | | |
| other stoichiometry) | | | | | | |
| Silicon oxide | 0-50% or | 5-30% or | 15-25% | 0-50% | 5-30% | 15-25% |
| (e.g., SiO₂ and/or | 0-15% | 5-15% | | | | |
| other stoichiometry) | | | | | | |
| Titanium oxide | 0-20% | 1-10% | 3-7% | 0-20% | 1-10% | 3-7% |
| (e.g., TiO₂ and/or | | | | | | |
| other stoichiometry) | | | | | | |
| Copper oxide | 0-20% or | 1-15% | 2-10% or | 0-14% or | 0.7-10% | 1.3-7% or |
| (e.g., CuO or | 0.1-20% | | 2-5% | 0.1-14% | | 2-5% |
| other stoichiometry) | | | | | | |

It is noted that “stoichiometry” as used herein covers, for example, oxygen coordination and oxygen state. Other compounds may also be provided in the primer material (e.g., see FIGS. 13-14). For example, on a weight basis, the primer material for one or both layers 31 and/or 32 may further comprise one or more of: 2-20% (or 2-7%) zinc oxide; 0-15% (or 2-7%) aluminum oxide; 0-10% (or 0-5%) magnesium oxide; 0-10% (or 0-5%) chromium oxide; 0-10% (or 0-5%) iron oxide; carbon dioxide; and/or other elements shown in the figures.

Table 6 sets forth example ranges for various elements and/or compounds for this example primer layer 31 and/or 32 material according to various example embodiments, for both mol % and weight %, after firing/sintering thereof and after hermetic edge seal 3 formation. It will be appreciated that other materials may be used together, or in place of, those shown below, and that the example percentages may be different in alternate embodiments.

TABLE 6
(example primer material after edge seal formation)

| | | More | Most | | More | Most |
|---|---|---|---|---|---|---|
| | General | Preferred | Preferred | General | Preferred | Preferred |
| | (Mol %) | (Mol %) | (Mol %) | (Wt. %) | (Wt. %) | (Wt. %) |
| bismuth oxide | 0.5-50% | 1-12% | 4-9% | 5-70% or | 20-50% or | 30-40% or |
| (e.g., Bi₂O₃ and/or | | | | 55-95% | 70-80% | 70-80% |
| other stoichiometry) | | | | | | |
| boron oxide | 10-50% | 15-40% | 20-30% | 5-50% | 10-35% | 15-25% |
| (e.g., B₂O3 and/or | | | | | | |
| other stoichiometry) | | | | | | |
| Silicon oxide | 0-50% or | 15-35% or | 22-30% | 0-50% | 5-35% | 15-30% |
| (e.g., SiO₂ and/or | 0-15% | 5-15% | | | | |
| other stoichiometry) | | | | | | |
| Titanium oxide | 0-20% | 3-12% | 4-11% | 0-20% | 3-12% | 4-11% |
| (e.g., TiO₂ and/or | | | | | | |
| other stoichiometry) | | | | | | |
| Copper oxide | 0-20% or | 1-15% | 2-10% or | 0-14% or | 0.7-10% | 1.3-7% or |
| (e.g., CuO or | 0.1-20% | | 2-5% | 0.1-14% | | 2-5% |
| other stoichiometry) | | | | | | |

Other compounds may also be provided in this primer material, as discussed above and/or shown in the figures. Certain elements may change during firing/sintering, and certain elements may at least partially burn off during processing prior to formation of the final edges seal 3. It will be appreciated that, as with other layers discussed herein, other materials may be used together, or in place of, those shown above and/or below, and that the example weight/mol percentages may be different in alternate embodiments. The ceramic sealing glass primer materials for layer(s) 31 and/or 32 are lead-free and/or substantially lead-free in certain example embodiments. The copper oxide may be replaced by and/or supplemented with another thermal diffusivity additive, such as silver oxide, nickel oxide, or the like in various example embodiments.

In various example embodiments, materials for the ceramic sealing glass primer layers 31 and/or 32 may be selected to produce a high degree of hermeticity on the order of, for example, 10⁻⁸ cc/m² per day for air penetration and/or 10⁻⁸ cc/m² per day for water penetration. Such a high degree of hermeticity may in part be achieved by reducing the PSD mean particle size (e.g., to less than about 20 μm, more preferably less than about 15 μm) and selecting a binder resin that burns out substantially uniformly to create a primer layer with a high degree of homogeneity. In certain example embodiments, one or both of the primer layers 31 and/or 32 may have one or more of: an average D50 particle size of from about 1-25 μm, more preferably from about 1-20 μm, more preferably from about 2-20 μm, more preferably from about 2-15 μm (more preferably from about 3-8 μm), an average D10 from about 0.10-4.0 μm, an average D90 particle size from about 15-25 μm and an example of about 25 μm, and/or an average D95 particle size less than about 30.0 μm.

Table 7 sets forth example ranges for various elements for the example primer material according to various example embodiments, using elemental analysis (non-oxide analysis) for both mol % and weight %, after firing/sintering thereof and thus after hermetic edge seal 3 formation. FIG. 14 also provides an elemental analysis for various example seal materials, including the primer material at the right side thereof. In certain example embodiments, one or both of primer layers 31 and/or 32 may comprise mol % of the following elements in one or more of the following orders of magnitude: B>Bi, O>B>Bi, O>B>C, O>B>Si>Bi, and/or B>Si>Bi>Ti, before and/or after firing/sintering of the layer and formation of the edge seal 3 (e.g., see also FIG. 14). It will be appreciated that other materials may be used together, or in place of, those shown below, and that the example percentages may be different in alternate embodiments.

TABLE 7
(elemental analysis - example primer material after
firing/sintering and after edge seal formation)

| | | More | Most | | More | Most |
|---|---|---|---|---|---|---|
| | | Pre- | Pre- | | Pre- | Pre- |
| | General | ferred | ferred | General | ferred | ferred |
| | (Mol | (Mol | (Mol | (Wt. | (Wt. | (Wt. |
| | %) | %) | %) | %) | %) | %) |
| Bi | 1-40% | 2-15% | 3-7% | 10-70% | 20-50% | 30-40% |
| Si | 3-40% | 4-20% | 6-13% | 3-40% | 4-20% | 6-13% |
| B | 3-40% | 5-30% | 10-20% | 1-30% | 2-20% | 4-10% |
| Ti | 0-20% | 1-10% | 2-5% | 1-30% | 3-20% | 4-9% |
| O | 30-80% | 40-70% | 50-60% | 10-55% | 20-45% | 30-40% |

The primer materials in FIGS. 13-14 and Table 7 may be considered to be boron-based, given that excluding oxygen, silicon, and carbon, boron has the largest magnitude in terms of mol % before and/or after firing/sintering. While other materials (e.g., bismuth based primers, solder glass, etc.) may be used for layer(s) 31 and/or 32 in certain example embodiments, boron-based material such as in FIGS. 13-14 and Table 7 may be desirable for use as primer layer(s) 31 and/or 32 in certain example embodiments, for example when laser heating is used for sintering/firing the main seal layer 30, as follows. Bismuth based primers, with little to no boron in terms of mol %, have been found to block large amounts of energy from the laser 41 so that it does not reach main seal layer 30 during firing/sintering of that layer. It has been found that by reducing Bi, and increasing B, in terms of mol %, the primer layer(s) 31 and/or 32 can be more transmissive of certain laser energy (e.g., from a near-IR laser, such as 808 nm, 810 nm, and/or 1064 nm) thereby allowing the main seal layer 30 to be more efficiently and quickly heated and sintered/fired without significantly de-tempering the glass substrate(s) 1 and/or 2. Thus, the boron-based (mol %) material(s) of FIGS. 13-14 and Table 7 may be used for one or both primer layer 31 and/or 32 in certain example embodiments, for instance when laser heating is used that impinges upon a primer layer. In certain example embodiments, one or both primer layer(s) 31 and/or 32 may comprise, in terms of mol %, the material of Table 7. In certain example embodiments, on an elemental basis (not including oxides) and in terms of mol %, primer layer(s) 31 and/or 32 may have a ratio B/Bi, of boron (B) to bismuth (Bi), of from about 1.1 to 10.0, more preferably from about 2.0 to 6.0, and most preferably from about 2.5 to 4.5 (with an example being about 3.7), after firing/sintering of the main seal layer 30 and/or primer(s). In certain example embodiments, in terms of mol % after sintering/firing of layer 30, primer layer(s) 31 and/or 32 may comprise at least two times as much B as Bi, more preferably at least about three times as much B as Bi, and/or may comprise at least about two time as much B oxide as Bi oxide, more preferably at least about three times as much B oxide as Bi oxide. Such a primer (e.g., 31) is thus able to allow sufficient near-IR energy from the laser (e.g., at 808 or 810 nm) to pass so that the main seal layer 30 can be efficiently and quickly fired/sintered, without significantly de-tempering glass and/or inducing significant transient thermal stress.

FIG. 15 is a table/graph showing density (g/cm³) vs. temperature (degrees C.) for two different example ceramic frit main seal layer 30 materials according to example embodiments, which seal material(s) may be used in combination with any embodiment herein including those of FIGS. 1-9. The upper curve in FIG. 15 is for a Te oxide based main seal 30 material as shown in FIGS. 11-12 and 14, whereas the lower curve in FIG. 15 is for a vanadium oxide-based seal 30 material the composition of which is illustrated in FIG. 15. The data in FIG. 15, for these two different example main seal layers 30, was taken after a binder burnout at about 325 degrees C. for about 15 minutes and sintering for about 15 minutes.

As shown in FIG. 15, it has been surprisingly found that the density of main seal layer 30 is a function of processing temperature. Higher density for the main seal layer 30 is desirable, because lower density results in increased porosity and an increased likelihood of moisture/air leakage through the seal. Thus, it can be seen that the Te oxide based main seal layer 30 material performed significantly better than the vanadium oxide based main seal layer 30 material, with respect to resulting density as shown in FIG. 15. The higher the density of the main seal layer 30, the better. For example, the 2.10 g/cm³ density for the vanadium oxide-based seal material (the lower curve in FIG. 15) when that material is exposed to sintering at around 405 degrees C. is a low density which can lead to the seal material being porous, poor water resistance, poor mechanical adhesion, difficulties maintaining hermiticity, and/or seal failures. Meanwhile, using essentially the same 405 degrees C. processing/sintering temperature, the Te oxide based main seal layer material (the upper curve in FIG. 15) had a much higher density of 3.20 g/cm³ which high density is excellent and provided for less porosity, good water resistance, good mechanical adhesion strength, and good hermiticity. Thus, while both materials may be used for example, it has been found that the Te oxide-based material is advantageous, due at least to a higher density, for main seal layer 30.

In certain example embodiments, main seal layer 30, after edge seal formation (e.g., via laser sintering), may have a density of at least about 2.75 g/cm³, more preferably of at least about 2.80 g/cm³, more preferably of at least about 2.90 g/cm³, more preferably of at least about 3.00 g/cm³, even more preferably of at least about 3.10 g/cm³, and most preferably of at least about 3.20 g/cm³. In certain example embodiments, the main seal layer 30, after edge seal formation (e.g., via laser sintering), may have a density of from about 2.80-4.00 g/cm³, more preferably from about 2.90-3.90 g/cm³, and most preferably from about 3.10-3.70 g/cm³ or 3.15-3.40 g/cm³. In certain example embodiments, these main seal layer 30 density ranges, preferably with a substantially lead-free ceramic material, may be in combination with a maximum processing temperature of the main seal layer 30 (e.g., during sintering and formation of the edge seal) during edge seal formation of no more than about 520 degrees C., more preferably no more than about 500 degrees C., and most preferably no greater than about 480 degrees C. For example, the main seal layer 30 may be of or include a material characterized by the above density ranges, after being processed at about 405 degrees C. for about 15 minutes. As explained above, such high densities advantageously provide for less porosity, good water resistance, good mechanical adhesion strength, and good hermiticity for the edge seal.

In certain example embodiments, one or both primer layer(s) 31 and/or 32 may have, after edge seal formation (e.g., via laser sintering), a density of at least about 2.75 g/cm³, more preferably of at least about 3.20 g/cm³, more preferably of at least about 3.40 g/cm³, more preferably of at least about 3.50 g/cm³, even more preferably of at least about 3.60 g/cm³. In certain example embodiments, one or both primer layers may have a density higher than the density of the main seal layer 30. The high density of the primer layer(s) is advantageous for improving hermiticity of the overall edge seal. In certain example embodiments, primer layer 31 and/or primer layer 32 may have a density of from about 3.0-4.2 g/cm³, more preferably from about 3.3-4.0 g/cm³, more preferably from about 3.5-3.8 g/cm³, more preferably from about 3.6-3.7 g/cm³. In certain example embodiments, primer layer 31 and/or primer layer 32 may have a density of at least about 0.20 g/cm³ higher (more preferably at least about 0.30 higher, more preferably at least about 0.40 higher) than a density of the main seal layer 30. For example, the main seal layer 30 may have a density of about 3.22 g/cm³ and the primer layers 31 and 32 may each have a density of about 3.66 g/cm³.

It has been found that designing the thermal diffusivity and/or thermal conductivity of primer layer 31 (through which the laser beam 40 passes when a primer layer 31 is used) and/or main seal layer 30 can advantageously reduce de-tempering of the glass substrate(s) 1 and/or 2 due to laser sintering/firing of the main seal layer 30. For example, the primer layer 31 may be designed and optimized to have a high thermal diffusivity and/or high thermal conductivity to rapidly transfer heat from the laser source through the primer layer 31 to the main seal layer 30 to more quickly sinter/fire the main seal layer 30 and wet the interfaces between the main seal layer 30 and opposing primer layers 31-32, without significantly de-tempering the glass substrates 1 and 2. In certain example embodiments, main seal layer 30 may have one or more of: a lower thermal conductivity than traditional amorphous glass materials, e.g., 0.88 W/mK versus 1.10 W/mK, a lower specific heat capacity, e.g., 0.132 cal/gK versus 0.200 cal/gK, and/or higher mass density, e.g., 3.16 g/cm³ versus 2.47 g/cm³. If one knows thermal conductivity (k) and specific heat capacity of a material, an example relationship for determining thermal diffusivity is D*=k(T)/(100×p(T)×Cp(T)), where D* is thermal diffusivity, k is thermal conductivity, p is mass density, and Cp is specific heat capacity. Further example equations for thermal conductivity (TC=k) and thermal diffusivity (TD=D*) are as follows:

$$k = {D}^{*} {pC}_{p} ( Thermal Conductivity )$$

$${D}^{*} = {c}_{x} ( {L}^{2} / {t}_{x} ) ( Thermal Diffusivity )$$

where k (TC) is thermal conductivity, D* (TD) is thermal diffusivity, p is mass density, Cₚ is specific heat capacity, cₛ is constant (0.303520), L is material thickness, and tₓ is time.

According to certain example embodiments, as shown in Table 8 thermal conductivity (TC) and thermal diffusivity (TD) measurements were taken of components of example vacuum insulated panels at a reference temperature of about 25 degrees C. by laser flash method ASTM E1461 for three examples each of main seal layers 30, primer layers 31, and glass substrates 1 in a vacuum insulating panel as shown using materials in FIGS. 2, 6-7, 9, and 11-14, after laser sintering of the main seal layer 30 via laser beam 40 through primer layer 31 and substrate 1, and after disassembly of the panels for measurement purposes. For each sample/example, laser flash thermal diffusivity (TD) measurements involved pulse heating the front side of the sample surface with a short laser pulse, and then measuring the time evolution of the back surface temperature using an IR detector; the resulting temperature profile curve was tailored using a one-dimensional heat flow model, and the sample's TD was then extracted from the model and thermal conductivity (TC) calculated using the TD, average density, and specific heat.

TABLE 8

| | Thermal | Thermal | | |
|---|---|---|---|---|
| | Conductivity | Diffusivity | Specific Heat | Density |
| | (W/mK) | (cm²/s) | (cal/gK) | (g/cc) |
| Main Seal 30 Ex. 1 | 0.8760 | 0.005432 | 0.132 | 2.918 |
| Main Seal 30 Ex. 2 | 0.8829 | 0.005475 | 0.132 | 2.918 |
| Main Seal 30 Ex. 3 | 0.8880 | 0.005506 | 0.132 | 2.918 |
| Primer 31 Ex. 1 | 1.1605 | 0.005611 | 0.135 | 3.659 |
| Primer 31 Ex. 2 | 1.1479 | 0.005550 | 0.135 | 3.659 |
| Primer 31 Ex. 3 | 1.1520 | 0.005570 | 0.135 | 3.659 |
| Glass Ex. 1 | 1.1178 | 0.005398 | 0.200 | 2.473 |
| Glass Ex. 2 | 1.1022 | 0.005323 | 0.200 | 2.473 |
| Glass Ex. 3 | 1.1135 | 0.005377 | 0.200 | 2.473 |

As shown in Table 8, for the main seal layers 30 the average thermal conductivity was 0.8823 W/mK and the average thermal diffusivity was 0.005471 cm²/s; for the primer seal layers 31 the average thermal conductivity was 1.1535 W/mK and the average thermal diffusivity was 0.005577 cm²/s; and for the soda-lime-silica based glass substrate 1 the average thermal conductivity was 1.1112 W/mK and the average thermal diffusivity was 0.005366 cm²/s. Thus, it can be seen that in certain example embodiments the main seal layer 30 has a lower thermal conductivity than the glass substrates 1 and/or 2, e.g., 0.88 W/mK for the main seal layer 30 versus from about 0.94 to 1.10 W/mK for the glass substrate(s); and that the following ratio may be met: TCml<TCg<TCpl, where TCml is the thermal conductivity of the main seal layer 30, TCg is the thermal conductivity of one or more of the glass substrates 1 and/or 2, and TCpl is the thermal conductivity of one or both primer layers 31 and/or 32. Too high of a thermal conductivity (e.g., for the main seal layer 30) can hurt insulating performance such as U-value.

In certain example embodiments, one or both of the ceramic sealing primer layers 31-32 of the edge seal 3, after firing/sintering, may have a thermal conductivity of from about 1.0 to 2.0 W/mK, more preferably from about 1.0 to 1.90 W/mK, more preferably from about 1.10 to 1.90 W/mK, more preferably from about 1.10 to 1.50 W/mK or from about 1.0 to 1.50 W/mK, more preferably from about 1.12 W/mK to 1.30 W/mK, even more preferably from about 1.14 W/mK to 1.25 W/mK, with other examples being from about 1.40 W/mK to 1.80 W/mK or about 1.60 W/mK. In certain example embodiments, primer layer(s) 31 and/or 32, after firing/sintering, may have a thermal conductivity of at least 1.00 W/mK, more preferably of at least 1.10 W/mK, more preferably of at least 1.12 W/mK, even more preferably of at least 1.13 W/mK, and most preferably of at least 1.14 or 1.15 W/mK. Many of these are higher than the thermal conductivity of the glass substrates 1 and 2. In certain example embodiments, main seal layer 30, after firing/sintering thereof, may have a thermal conductivity of from about 0.75 to 1.30 W/mK, more preferably from about 0.75 to 1.20 W/mK, more preferably from about 0.75 to 1.00 W/mK, more preferably from about 0.80 to 1.00 W/mK, more preferably from about 0.80 to 0.95 W/mK, more preferably from about 0.85 to 0.95 W/mK, even more preferably from about 0.86 to 0.90 W/mK. Thus, it will be appreciated, that in certain example embodiments the thermal conductivity of the glass substrate 1 and/or 2 is between the thermal conductivity of the main seal layer 30 and the thermal conductivity of the primer layer 31 (TCml<TCg<TCpl), with the primer layer 31 having the highest thermal conductivity of the three for more efficient heat transfer to layer 30 during edge seal formation in certain example embodiments where a primer layer 31 is used. In certain example embodiments, the ratio TCpl/TCg of the thermal conductivity of the primer layer 31 (and/or 32) to the thermal conductivity of the glass substrate 1 and/or 2 may be at least 0.950, more preferably at least 1.00, more preferably at least 1.020, more preferably at least 1.030, even more preferably at least 1.035, with an example based on averages in Table 8 being 1.038. In certain example embodiments, the ratio TCpl/TCml of the thermal conductivity of the primer layer 31 (and/or 32) to the thermal conductivity of the main seal layer 30 may be from about 1.2 to 1.5, more preferably from about 1.25 to 1.40, and most preferably from about 1.28 to 1.33, with an example being 1.31 based on averages in Table 8.

In certain example embodiments, one or both of the ceramic sealing primer layers 31-32 of the edge seal 3, after firing/sintering, may have a thermal diffusivity of from 0.0050 to 0.0070 cm²/s, more preferably from 0.0050 to 0.0065 cm²/s, more preferably from 0.0054 to 0.0065 cm²/s, more preferably from 0.0054 to 0.0058 cm²/s, even more preferably from 0.0055 to 0.0057 cm²/s, with an example being 0.0056 based on averages in Table 8. In certain example embodiments, main seal layer 30, after firing/sintering thereof, may have a thermal diffusivity of from 0.0050 to 0.0085 cm²/s, more preferably from 0.0050 to 0.0065 cm²/s, more preferably from 0.0054 to 0.0058 cm²/s, even more preferably from 0.0054 to 0.0056 cm²/s, with an example being 0.0055 based on averages in Table 8. Glass substrate(s) 1 and/or 2 may have a thermal diffusivity of about 0.0053 to 0.0054 cm²/s in certain example embodiments. Thus, it will be appreciated, that in certain example embodiments the thermal diffusivity of the glass substrate 1 and/or 2 may be less than the thermal diffusivity of the main seal layer 30 (TDg<TDml) and/or less than the thermal diffusivity of the primer layer 31 (TDg<TDpl), where TDg is the thermal diffusivity of the glass substrate(s), TDpl is the thermal diffusivity of primer layer 31 and/or 32, and TDml is the thermal diffusivity of the main seal layer 30. In certain example embodiments, TDpl>TDml. In certain example embodiments, the ratio TDpl/TDg may be at least 1.020, more preferably at least 1.030, even more preferably at least 1.035, with an example based on averages in Table 8 being 1.039. In certain example embodiments, the ratio TDpl/TDml may be at least 1.000, more preferably at least 1.010, even more preferably at least 1.015, with an example based on averages in Table 8 being 1.019.

These thermal diffusivity and/or thermal conductivity ratios and values advantageously allow(s) rapid transfer of heat from the laser source through the primer layer 31 to the main seal layer 30 to quickly sinter/fire the main seal layer 30 and wet the interfaces between the main layer 30 and opposing primer layers 31-32, without significantly de-tempering the glass substrates 1 and 2 during edge seal formation. For instance, the higher the thermal diffusivity and/or thermal conductivity of the primer layer 31 and/or main seal layer 30, (a) the less laser power needed, (b) the less chance of significant de-tempering and/or cracking of the glass substrate 1 and/or 2, and/or (c) thermal stress can be reduced or minimized. Any of these ratio(s) and/or value(s) may be used in combination with any other of these ratio(s) and/or value(s), and may be used in combination with any embodiment(s) herein.

A thermal diffusivity/conductivity additive(s) such as metallic copper or copper oxide (e.g., CuOₓ, where x may be from about 0.2 to 1.5, more preferably from about 0.5 to 1.4, more preferably from about 0.8 to 1.2, more preferably from about 0.9 to 1.1, with an example being about 1.0) may be added to the material for one or more of main seal layer 30, primer layer 31, and/or primer layer 32, in order to increase thermal diffusivity and/or absorption of the seal material so that seal layer 30 can be laser sintered more quickly and/or more efficiently in the manufacturing process. Such an addition of copper oxide results in increased thermal diffusivity and/or increased thermal conductivity of the seal layer in which it is present, allowing for heat to be more easily absorbed and/or transferred, providing for more efficient seal firing and/or sintering, and/or reduced glass de-tempering. For example, the additive (e.g., CuOₓ) may allow the laser 41 to be run faster during firing and/or sintering of the seal material 30, which may result in faster manufacturing times and/or less glass de-tempering. The addition of a thermal diffusivity/conductivity additive(s), such as copper oxide (e.g., CuOₓ), to the main seal layer 30 may allow the primer layer(s) 31 and/or 32 to be thinned and/or omitted in certain example embodiments, and/or may allow for vanadium in layer 30 to be reduced or omitted. For example, the addition of a thermal diffusivity/conductivity additive(s), such as copper oxide (e.g., CuOₓ) or other material discussed herein, to the main seal layer 30 may allow the primer layer 31 to be omitted as shown in FIG. 5. This copper oxide thermal diffusivity/conductivity additive, in one or more of layers 30, 31 and/or 32, may be replaced and/or supplemented with other additive material(s) such as one or more of molybdenum oxide (e.g., MoO₃ and/or MoO₅), silver, silver oxide, nickel oxide, aluminum, aluminum oxide (e.g., Al₂O₃ or other stoichiometry), or the like, in various example embodiments. While the additive may be added to main seal layer 30, such thermal diffusivity/conductivity additive(s) may also or instead be added to material for primer layer 31 and/or 32 in certain example embodiments.

In certain example embodiments, one or more of main seal layer 30, primer layer 31, and/or primer layer 32 may include a thermal diffusivity/conductivity additive (e.g., CuOₓ) in an amount of from about 0.1-20%, more preferably from about 1-15%, more preferably from about 1-10%, more preferably from about 2-10%, and most preferably from about 2-5%, in terms of mol %. These amounts/ranges also apply to other possible thermal diffusivity/conductivity additives which may be used instead of copper oxide, or in addition thereto, such as metallic copper, molybdenum oxide, aluminum, aluminum oxide (stoichiometric or sub-stoichiometric), silver, and/or silver oxide. When metallic particles, such as copper, silver, or aluminum particles, are added it is expected that such particles will at least partially oxidize during heating so as to be at least partially oxided in the seal 3 of the final panel.

The thermal diffusivity/conductivity additive(s) (e.g., CuOₓ) may have a small particle size, such as an average D50 particle size of from about 5 nm to 15 μm, more preferably from about 5-500 nm, and more preferably from about 10-100 nm. The small particle size of the thermal diffusivity/conductivity additive (e.g., CuOₓ) is technically advantageous because, for example and without limitation, this allows for the seal layer in which it is present (e.g., layer 30) to have an increased density and thus improved moisture resistance, and allows the layer 30 to be sintered more easily and/or quickly. The small particle sizes also allows for the thermal diffusivity/conductivity additive(s) to be more evenly distributed throughout layer(s) in which it is present, which improves heat transfer functionality related to the layer's improved thermal diffusivity and thermal conductivity, as for example heat can be more efficiently absorbed by the additive and transferred during sintering to the tellurium oxide. In certain example embodiments, the additive(s) (e.g., CuOₓ) may be provided in seal material entirely or partially in a form of nanoparticles or colloidal nanocrystal particles.

Different stoichiometries/oxidation states of copper oxide (e.g., CuOₓ) have different absorption characteristics, as shown in FIG. 17 for example. For example, CuO has an absorbance peak at high wavelength(s) around 700-750 nm and a thermal conductivity of about 30-70 W/mK, whereas Cu₂O (same as CuO_{0.5}) has an absorbance peak at lower wavelengths(s) around 460-470 nm and a lower thermal conductivity (e.g. see FIG. 17). Metallic copper (x=0) has a much higher thermal conductivity than does CuO, and absorbs light at all wavelengths. Thus, when using CuOₓ as a thermal diffusivity/conductivity additive, “x” may be selected based on the wavelength of the laser 41 used to fire and/or sinter the seal layer 30. For example, if a 480 nm laser 41 is used to fire and/or sinter the seal material 30, then the copper oxide additive may be of or include Cu₂O (same as CuO_{0.5}, where x=0.5) or similar stoichiometry, because this stoichiometry has a peak absorption close to the 546 nm wavelength. As another example, if an 808 nm laser 41 is used to fire and/or sinter the seal material 30, then the copper oxide additive may be of or include CuO (where x=1) or similar stoichiometry, because this stoichiometry has a peak absorption closer to the 808 nm wavelength. As another example, if a 532 nm or 546 nm laser 41 is used to fire and/or sinter the seal material 30, then the copper oxide additive may be of or include a mixture of CuO (where x=1) and Cu₂O (same as CuO_{0.5}, where x=0.5), or similar stoichiometry, because this mixture will realize a peak absorption around 600 nm and thus closer to the 532 nm and 546 nm wavelengths. As another example, if a 700 nm laser 41 is used to fire and/or sinter the seal material 30, then the copper oxide additive may be of or include CuO (where x=1) or similar stoichiometry, because this stoichiometry has a peak absorption closer to the 700 nm wavelength. Thus, in various example embodiments, for example and without limitation, the copper oxide additive may be made up entirely or partially of CuO (where x=1), entirely or partially of Cu₂O (same as CuO_{0.5}, where x=0.5), entirely or partially of CuO_{0.8}, entirely or partially of CuO_{0.9}, entirely or partially of CuO_{0.4}, any combination of these, or any other suitable stoichiometry (ies)/oxidation state. In certain example embodiments, “x” in CuOₓ (or other metal oxide MOₓ, where M is the metal) may be based on the wavelength of the laser 41, so that for example a peak absorption of the CuOₓ (or other metal oxide MOₓ) is within about 150 nm of the laser's wavelength, more preferably within about 100 nm of the laser's wavelength. As another example, when aluminum and/or aluminum oxide is used as a thermal diffusivity additive, one or the absorption peaks for metallic aluminum is proximate 800 nm (a material can have multiple peaks of different magnitudes), and as becomes oxidized the absorption curve pulls back through visible wavelengths with a peak being in the UV region-thus, metallic or substantially metallic aluminum may be desirable in seal material as a thermal diffusivity additive may be desirable when using an 800 nm or 808 nm laser for example because this would allow an absorption peak for the material to be proximate the laser's wavelength, but it should be appreciated that during heating the aluminum may become oxided or further oxided so as to be oxided in the final panel.

Further details of the edge seal structure, dimensions of the edge seal and other components, characteristics of the edge seal and other components, materials, laser processing, and the manufacturing of the overall panel may be provided in one or more of U.S. patent application Ser. Nos. 18/376,914, 18/376,473, 18/376,479, 18/376,483, 18/379,275, and 18/510,777, the disclosures of which are all hereby incorporated herein by reference in their entireties.

FIG. 16 is a flowchart illustrating example steps in making a vacuum insulating panel according to various example embodiments, which may be used in combination with any embodiment herein. Steps 201-204 apply to one of the two substrates, while steps 205-209 apply to the other one of the substrates, and steps 210-213 apply when the substrates are mated to each other via clamping, sealing, and/or the like.

A substrate (e.g., substrate 1 in FIG. 2) is provided in step 201, and another substrate (e.g., substrate 2 in FIG. 2) is provided in step 205. The substrate in step 205 may have a low-E coating 7 provided thereon, which may be edge-deleted in step 206. A primer layer (e.g., 31 in FIG. 2) may be applied to the corresponding substrate (e.g., substrate 1 in FIG. 2) in step 202, whereas the other primer layer (e.g., 32 in FIG. 2) may be applied to the other substrate (e.g., substrate 2 in FIG. 2) in step 207. In various example embodiments, one or both ceramic sealing glass primer layers 31-32 may be boron oxide inclusive and/or bismuth oxide inclusive, and may be applied using silk screen printing, digital printing, pad printing, extrusion coating, ceramic spray coating or nozzle dispense methods. The primer layer(s) 31 and/or 32 may be deposited to achieve a sintered width of about 10 mm around the periphery of the substrates. In certain example embodiments, one or both primer layers may be applied to the glass surface at a thickness from about 40% to 60% higher than the desired target thickness. In an example embodiment, each primer layer as initially deposited may have a solids content of about 75 wt %, solvent about 24 wt. %, and binder about 1 wt. %. The substrates, with respective primers thereon, may then be thermally heated to remove solvents in the material using one of the following substrate heating methods or a combination thereof: radiation, convection, induction, microwave or conduction. The substrates may be heated between 100 degrees C. to 250 degrees C. for 30 seconds to ten minutes to remove the solvents from the sealing glass material with an example temperature being 180 degrees C. for about 4 minutes. Substrates may then be thermally heated to remove organic resin materials in the sealing glass primer material using one of the following substrate heating methods or a combination thereof; radiation, convection, induction, microwave or conduction, such as for example to from 275 degrees C. to 400 degrees C. for 30 seconds to ten minutes with an example temperature being about 320 degrees C. for 6 minutes. The removal of the organic resin material from the primers may be referred to as ceramic sealing glass binder burnout. In steps 203 and 208, the substrates may then be thermally heated for thermally tempering the glass substrates and to sinter and fire the ceramic primer material to the desired physical thickness and material properties using one of the following substrate heating methods or a combination thereof: radiation, convection, induction, microwave or conduction. For example, the substrates 1 and 2 may be heated to from between 575 degrees C. to 700 degrees C. for 30 seconds to five minutes depending on the thickness of the substrates with an example temperature being 625 degrees C. at a rate of 30 seconds per mm of uncoated glass thickness and 60 second per mm of Low-E coated glass thickness. Thus, the primer layers 31-32 are fired/sintered when the corresponding glass substrates 1 and 2 are thermally tempered, in certain example embodiments, in steps 203 and 208. When heat strengthen glass is used instead of tempered glass, in certain example embodiments, the primer layers 31 and/or 32 may be sintered in a step that does not involve tempering. Thus, the primer layers may be dried at a temperature of about 180 degrees C. to substantially remove solvents in the sealing glass matrix using thermal heat, and then be thermally heated a temperature of about 320 degrees C. to burn out the resin binders that provide the carrier vehicle for the sealing glass paste material, and then be sintered at 625 degrees C. while the glass substrates 1, 2 are thermally tempered to achieve desired properties.

In certain example embodiments, the sintered/fired primer layers 31-32 may be opaque or semi-opaque to visible light with an optical density >0.80 or >0.250. In an example embodiment, a sinter/fired primer may have a physical thickness between about 20 to 240 microns, more preferably from about 160 microns to about 240 microns, with an example thickness(es) of about 145 or 200 microns for primer layer 32, and about 45 microns for primer layer 31. The primer layer on one substrate may be deposited substantially thicker than the primer layer on the other substrate. The primer layer(s) may be opaque or substantially opaque to laser energy over the spectral range of 370 nm to 1500 nm above a minimum thickness, but may transmit a reasonable amount of laser energy at thicknesses below 60 microns for example. In certain example embodiments, primer layer 31 may be transmissive to from about 1-35% of a laser beam at one or more of 808, 810, or 1064 nm. The total perimeter seal thickness may be about 280 microns. The thicknesses of the thick primer layer 32, thin primer layer 31 and main seal layer 30 can be optimized to attain desired processing conditions.

In certain example embodiments, in steps 203 and 208, the primer layers 31 and 32 may bond to and/or diffuse into the respective glass substrates upon which they are located since the glass substrates 1, 2 are above the glass softening point, and create a high adhesion strength to the glass substrates. Interdiffusion of the primer layer(s) into the respective glass substrate(s) results in a high adhesion strength to the glass substrates, as for example SiO₂ in the primer layer(s) bond to a silicon-rich layer in a soda lime silicate float glass in certain example embodiments. For example, adhesion strength using lap shear mechanical test methods may be from about 60-120 kg per cm², which is higher than the modulus of rupture of soda lime silicate glass substrates. The primer layers may have a high degree of hermeticity, e.g., less than 1×10⁻⁸ cc/m²/day of vacuum loss, low moisture vapor transmission rates, and/or provide high levels of mechanical adhesion to the glass substrates, in certain example embodiments. The primer layers may have a CTE of about 8.0-8.80×10⁻⁶ or about 8.2-8.35×10⁻⁶, and may act as a CTE buffer between the glass substrates with a CTE of about 8.8-9.2 (e.g., about 9.0×10⁻⁶) and the main seal layer 30 with a CTE of about 7.2-8.0×10⁻⁶ or 7.4-8.0×10⁻⁶ (e.g., about 7.60×10⁻⁶) in certain example embodiments.

In step 204, the ceramic sealing glass main layer 30 (e.g., which may be Te oxide based or inclusive) may then applied to one of the glass substrates over the primer layer (e.g., over primer 31, or over primer 32), such as via silkscreen printing, ceramic spray, extrusion coating, digital printing, pad printing, nozzle dispense or other commercially available ceramic sealing material application methods. The layer 30 may have tellurium oxide as a material with the highest weight percentage and vanadium oxide as a material with the second highest weight percentage, in certain example embodiments. Layer 30 may initially be applied at a thickness that is 30-60% higher (or 40-60% higher) than the desired target thickness for the layer. The main seal layer 30 may then be thermally dried to remove solvents in the sealing glass matrix. The substrate may be thermally heated to remove solvents in the material using one of the following substrate heating methods or a combination thereof; radiation, convection, induction, microwave and/or conduction. The substrate may be heated between 100 degrees C. to 250 degrees C. for 30 seconds to ten minutes to remove the solvents from the material with an example temperature being about 180 degrees C. for about 4 minutes.

After the spacers are provided on a substrate in step 209, the two glass substrates 1 and 2 may then be mated together and clamped around the periphery of the vacuum insulated unit to create a mated unit in step 210. The pump-out tube 12 and preform 13 may be applied to the substrate having recess 15 between steps 210 and 211 in certain example embodiments. The mated unit may then be thermally heated to burn out the resin binders that provide the carrier vehicle for the sealing glass paste material and then pre-glazed at a temperature of about 370 degrees C. to impart mechanical strength properties and performance between the main layer and primer layer(s). For example, mechanical adhesion strength after the mated unit has been pre-glazed may be about 30 kg per cm² and can be up to 100 kg per cm². For example, the perimeter of the vacuum insulated glass unit may be physically clamped with a controlled pressure to assist in setting the final thickness/height of the edge seal 3. The substrates may then be thermally heated to remove organic resin materials in the main sealing glass material 30 using one of the following substrate heating methods or a combination thereof; radiation, convection, induction, microwave or conduction. The binder burnout duration may be optimized so that much or substantially all binder is removed from the main layer 30 and the target density and/or porosity may be achieved. After binder burnout of the main layer 30, the physical thickness may be about 10% to 20% thicker than the target final thickness. In various example embodiments, a heating ramp rate(s) may be provided for the binder burn-out, so that air pores or air sinks may be removed from the main layer 30 to create a sealing glass layer with a high density and/or controlled/limited porosity. An example temperature ramp rate may be between about 4 degrees C. per minute and 20 degrees C. per minute, between the initial binder burnout temperature and the main layer glass transition temperature to burn out binder to a given level, as residual carbon in the main layer may impact vacuum cavity pressure. The mated unit may be heated between 250 degrees C. to 350 degrees C. for 30 seconds to twenty minutes with an example material temperature of 320 degrees C. and a duration of 8 minutes, in certain example embodiments; and/or heated between 340 degrees C. to 390 degrees C. for 30 seconds to ten minutes with an example material temperature of 370 degrees C. and a duration of 8 minutes. The mated unit may be heated to about 370 degrees C. to pre-glaze the main layer 30 in certain example embodiments. The pre-glaze may one or more of: (1) create a strong mechanical bond between the primer layer(s) and the main seal layer; (2) the main seal layer may reach or substantially reach its target thickness so the mechanical clamps may be removed prior to laser sintering; and/or (3) reduce process requirements for the laser to enable high linear rates. For example, prior attempts to use laser sintering for vacuum insulated glass have been problematic because the laser used to pre-glaze the material, wet the interfaces, sinter the material and melt the material to remove air pores; most sealing glass materials have a pre-glaze temperature in the range of 420 to 460 degrees C. which is too high and will de-temper the glass during processing. In certain example embodiments, we are able to use a low-temperature sealing glass that is pre-glazed for a short duration (e.g., at 370 degrees C.) thereby significantly reducing processing requirements for laser wetting, firing, and/or sintering. In certain example embodiments, main seal layer 30 pre-glaze density may be from 3.0-4.0 or 3.2-3.8 grams per cm², with an example being about 3.6 grams per cm². In certain example embodiments, mechanical adhesion strength after the mated unit has been pre-glazed may be about 30 kg per cm² and can be up to at least 100 kg per cm².

In step 211, the mated unit may then be pre-heated to an ambient temperature of about 320 degrees C. (e.g., see pre-heating discussion above). The mated unit can be pre-heated using radiation, convection and/or conduction for example, with an example being a precision hot plate incorporating convective heating to achieve desired thermal uniformity across the substrate surfaces. The mated pair may be heated to 320 degrees C. to minimize or reduce the thermal delta between the glass substrate temperature and the sintering point of the main seal layer 30 (e.g., which may be from about 390 degrees C. to 410 degrees C.) in certain example embodiments, so as to reduce transient thermal stress in the sealing glass materials. For example, transient thermal stress may be about 50 MPa without pre-heating to raise the ambient substrate temperature versus less than 10 MPa with pre-heating the glass substrates to about 320 degrees C.

In step 212, a laser (e.g., an 800 nm, 808 nm, 810 nm, or 940 nm continuous wave laser) 41 may then be used to locally and selectively sinter/fire the main seal layer 30. For example, the laser 41 and/or laser beam 40 may move around the periphery of the vacuum insulated unit using an XYZ gantry robot at a defined linear rate to wet the interface between the fully sintered primer layers 31, 32 and the pre-glazed main seal layer 30, sinter the main seal layer 30 to its final state (e.g., thickness, density and porosity) to reduce the size of air pores in the main seal layer 30 and/or at the main layer to primer interface. The laser linear speed, laser power, laser beam size, laser irradiation time, and/or laser thermal decay time may be optimized to achieve desired physical, chemical and/or mechanical properties. For example, the main seal layer 30 may be processed to achieve a sintered width of about 6 mm around the periphery of the vacuum insulated unit. In certain example embodiments, the main layer may be sintered and/or fired using the principle of thermal diffusivity, instead of direct photopic radiation. The glass substrates 1 and 2 may be substantially transparent to the laser energy for example, with around 80% of the laser energy reaching the thin primer layer 31. The thin primer layer 31 at a thickness of 40 microns for example, may act as a graded absorbing layer wherein around 20% of the photopic radiation reaches the primer layer 31 to main seal layer 30 interface. The thickness of the thin primer layer 31 and main seal layer 30 may be optimized to allow the main layer to be sintered and/or fired at a given laser linear rate, power level, beam size, irradiation spot time and/or spot temperature using the principle of thermal diffusivity. The thin primer layer 31 and main seal layer 30 thermal conductivity and density may be designed to increase or maximize the thermal diffusivity rate between the two layers. The seal 13 around the pump-out tube 12 may be laser sintered/fired using the same or a different laser. In various example embodiments, a continuous wave 808-nm or 810-nm laser may be used to one or more of: (1) wet the surface or interface between the thin primer layer 31 and main seal layer 30 and the thick primer layer 32 and the main seal layer 30 to achieve for example a target 40 kg/cm² mechanical adhesion; (2) locally sinter/fire the main seal layer 30 to densify material; and/or (3) locally sinter the main layer material to fill in air voids/pores at the main seal layer 30 to primer layer(s) interface(s) that were generated during the main seal layer application process. While any type of laser may be used in various embodiments for sintering layer 30, a continuous wave laser may be preferred over a scanning/rastering laser scanning lasers may involve multiple pulses at a given irradiation spot resulting in a series of heating and cooling events that can increase transient stress and raise the final residual stress, which could result in micro-cracks that result in no or poor hermeticity. The sintered main seal layer 30 may have an example density of about 3.16 g/cc (g/cm³) which is considerably higher than the soda lime silicate base glass, 2.50 g/cc, and a porosity of less than 0.02%.

In various example embodiments, wetting, sintering and/or firing may be achieved using localized laser energy to raise the main seal layer 30 material from the ambient substrate temperature (e.g., 320 degrees C.) to an example target temperature range of about 390 degrees C. to about 410 degrees C., based on using thermal diffusivity based on Fourier's Law to transfer heat from the laser power source to the main sealing glass layer 30 passing through a semi-transparent glass substrate, opaque to semi-transparent thin primer layer 31, and the semi-opaque or opaque main layer 30, as opposed to direct photopic radiation from the laser beam itself. In various example embodiments, the overall thickness of the thin primer layer 31 and the main seal layer 30 may be based on the thermal diffusivity rate and/or irradiation time. In various embodiments, the laser beam 40 shape may be Gaussian with the area above an example target temperature range of 425 degrees C. to 450 degrees C. possibly comprising at least 70% of the Gaussian profile or preferably at least 85% of the Gaussian profile. The laser beam shape may be a rectangular or plateau shaped beam with at least 80% of the profile above an example target temperature range of 425 degrees C. to 450 degrees C., for example 90% of the profile being above an example target temperature range of 425 degrees C. to 450 degrees C. In various example embodiments, the laser may heat the main seal layer 30 material to a temperature between 370 degrees C. and 430 degrees C., for example from about 390 degrees C. and 410 degrees C., to sinter the main layer sealing glass material. The laser peak temperature at the glass substrate may be between 425 degrees C. and 450 degrees C., with an example of about 435 degrees C. as measured by pyrometer, in certain example embodiments. The ceramics sealing glass temperature may, for instance, be represented by the following formula in certain example embodiments:

$$T = KP / ( {a}^{2} \times SQRT ( v \times D \times e \times L ) )$$

Where K=Scaling Coefficient; P=Laser Power; a=beam diameter; D heat diffusivity; e=laser radiation absorption in the sealing glass material(s); and L=sealing glass height. In certain example embodiments, the vacuum insulated glass unit may be heated on a hot plate over a temperature range of 275 degrees C. and 350 degrees C. (e.g., 320 degrees C.) for the pre-heating. Preheating of the vacuum insulated glass unit may lead to a noticeable decrease of laser energy demand for the forming of reliable joining of the two substrates. Preheating may increase the process window relative to too much energy demand causing cracks in the ceramic sealing glass materials and/or insufficient energy demand resulting in delamination sites due to insufficient mechanical bonding between the main seal ceramic sealing glass material and the primer(s). Laser power levels may be reduced up to 50 percent with elevated substrate temperatures and there may be marked reduction in ceramic sealing glass micro-cracking during the cooling phase of the process.

In step 213, the vacuum insulating panel is then evacuated to a low pressure using the pump-out tube 12, the tube closed off, and a cap 14 may be applied thereto. For example, the vacuum insulating panel may have one or more of: a compressive surface stress of at least about 12,000 psi, a central tensile stress of at least about 6,000 psi, a center to edge stress gradient of no more than about 2,000 psi, a glass edge stress greater than about 9,700 psi, a high degree of hermeticity of about 1×10⁻⁸ cc/m²/day, a lap shear mechanical strength of at least 30 kg per cm², a high thermal edge strength supporting an inner to outer glass substrate asymmetric thermal stress load of at least 70 degrees C., and/or any combination thereof.

In an example embodiment, there may be provided a vacuum insulating panel comprising: a first substrate (e.g., 1); a second substrate (e.g., 2); a plurality of spacers (e.g., 4) provided in a gap between at least the first and second substrates, wherein the gap is at pressure less than atmospheric pressure; a seal (e.g., 3) provided at least partially between at least the first and second substrates, the seal comprising a first seal layer (e.g., 30); and wherein the first seal layer comprises tellurium oxide and from about 0.1 to 20% (mol %) copper oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %.

In an example embodiment, there may be provided a vacuum insulating panel comprising: a first glass substrate (e.g., 1); a second glass substrate (e.g., 2); a plurality of spacers (e.g., 4) provided in a gap (e.g., 5) between at least the first and second glass substrates, wherein the gap (e.g., 5) is at pressure less than atmospheric pressure; a seal (e.g., 3) provided at least partially between at least the first and second substrates, the seal comprising a seal layer (e.g., 30, 31 or 32) (e.g., a first seal layer, and/or a second seal layer); wherein the seal layer (e.g., 30, 31 or 32) has an average D50 particle size of from about 1-25 μm (more preferably from about 1-20 μm, more preferably from about 3-20 μm, more preferably from about 5-20 μm); and wherein the seal layer (e.g., 30, 31 or 32) comprises a metal oxide (e.g., at least one of copper oxide, silver oxide, nickel oxide, aluminum oxide, molybdenum oxide, or the like) configured to increase the thermal diffusivity and/or thermal conductivity of the seal layer compared to if the metal oxide was not present, wherein the metal oxide has an average particle size (D50) of from about 5-500 nm (more preferably from about 10-100 nm).

In an example embodiment, there may be provided a vacuum insulating panel comprising: a first substrate (e.g., 1); a second substrate (e.g., 2); a plurality of spacers (e.g., 4) provided in a gap (e.g., 5) between at least the first and second substrates, wherein the gap is at pressure less than atmospheric pressure; a seal (e.g., 3) provided at least partially between at least the first and second substrates, the seal comprising a first seal layer (e.g., 30); wherein the first seal layer comprises tellurium oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %; and wherein the first seal layer further comprises from about 0.1 to 20% (mol %) of at least one of: copper, copper oxide, molybdenum oxide, nickel oxide, aluminum, aluminum oxide, and/or silver oxide.

In an example embodiment, there may be provided a vacuum insulating panel comprising: a first glass substrate (e.g., 1); a second glass substrate (e.g., 2); a plurality of spacers (e.g., 4) provided in a gap (e.g., 5) between at least the first and second glass substrates, wherein the gap is at pressure less than atmospheric pressure; a seal (e.g., 3) provided at least partially between at least the first and second substrates, the seal comprising a first seal layer (e.g., 30); wherein the first seal layer has a melting point (Tm) of from about 300 to 450 degrees C.; and wherein the first seal layer comprises tellurium oxide and from about 0.1 to 20% (mol %) copper oxide.

In an example embodiment, there may be provided a method of making a vacuum insulating panel, the vacuum insulating panel comprising a first glass substrate (e.g., 1), a second glass substrate (e.g., 2), a plurality of spacers (e.g., 4) provided in a gap (e.g., 5) between at least the first and second glass substrates, and a seal (e.g., 3) provided at least partially between at least the first and second glass substrates, the seal comprising a seal layer (e.g., 30, 31, and/or 32) (e.g., a first seal layer or a second seal layer); wherein the method comprises: providing seal material for the seal layer (e.g., first seal layer and/or second seal layer) in a location between at least the first and second glass substrates; heating, using a laser beam (e.g., 40) from a laser (e.g., 41), to form the seal; wherein the seal layer and/or the seal material comprises CuOₓ, where x is from about 0.2 to 1.5, and wherein x is based on a wavelength of the laser beam; and after forming the seal, evacuating the gap (e.g., 5) to a pressure less than atmospheric pressure.

In an example embodiment, there may be provided a method of making a vacuum insulating panel, the vacuum insulating panel comprising a first glass substrate (e.g., 1), a second glass substrate (e.g., 2), a plurality of spacers (e.g., 4) provided in a gap (e.g., 5) between at least the first and second glass substrates, and a seal (e.g., 3) provided at least partially between at least the first and second glass substrates, the seal comprising a seal layer (e.g., 30, 31, and/or 32) (e.g., a first seal layer and/or a second seal layer); wherein the method comprises: providing seal material for the seal layer in a location between at least the first and second glass substrates; heating, using a laser beam (e.g., 40) from a laser (e.g., 41), in order to form the seal; wherein the seal material and/or the seal layer comprises from about 0.1 to 20% (mol %) of at least one of: copper, copper oxide, molybdenum oxide, nickel oxide, aluminum, aluminum oxide, and/or silver oxide; wherein said at least one of copper, copper oxide, molybdenum oxide, nickel oxide, aluminum, aluminum oxide, and/or silver oxide is configured to increase a thermal diffusivity and/or thermal conductivity of the seal material and/or seal layer and so as to have a peak and/or high absorption within about 150 nm of the wavelength of the laser beam; and after forming the seal, evacuating the gap (e.g., 5) to a pressure less than atmospheric pressure.

In the vacuum insulating panel or method of any of the preceding six paragraphs, the first seal layer may comprise from about 1-15% copper oxide (mol %), more preferably from about 2-10% copper oxide (mol %), more preferably from about 2-5% copper oxide (mol %).

In the vacuum insulating panel or method of any of the preceding seven paragraphs, the copper oxide may comprise CuOₓ, where x is from about 0.2 to 1.5, more preferably from about 0.5 to 1.4, more preferably from about 0.8 to 1.2.

In the vacuum insulating panel or method of any of the preceding eight paragraphs, the copper oxide may have an average particle size (D50) of from about 5 nm to 15 μm, more preferably from about 5-500 nm, more preferably from about 10-100 nm.

In the vacuum insulating panel or method of any of the preceding nine paragraphs, the metal oxide (e.g., copper oxide) may comprise nanocrystals and/or nanoparticles.

In the vacuum insulating panel or method of any of the preceding ten paragraphs, the first seal layer may comprise from about 40-90% (mol %) tellurium oxide, more preferably from about 40-70% (mol %) tellurium oxide.

In the vacuum insulating panel or method of any of the preceding eleven paragraphs, the first seal layer may comprise from about 20-80% (wt. %) tellurium oxide, more preferably from about 40-70% (wt. %) tellurium oxide.

In the vacuum insulating panel or method of any of the preceding twelve paragraphs, the first seal layer may comprise tellurium oxide which may comprise TeO₃₊₁, wherein the first seal layer may comprise more TeO₃ than TeO₃₊₁ by mol %.

In the vacuum insulating panel or method of any of the preceding thirteen paragraphs, the first seal layer may comprise tellurium oxide, and from about 60-95%, more preferably from about 70-90%, of Te in the first seal layer may be in a form of TeO₃.

In the vacuum insulating panel or method of any of the preceding fourteen paragraphs, the first seal layer may comprise tellurium oxide, and from about 3-35%, more preferably from about 5-25%, of Te in the first seal layer may be in a form of TeO₄.

In the vacuum insulating panel or method of any of the preceding fifteen paragraphs, the first seal layer may comprise tellurium oxide, and from about 1-9% of Te in the first seal layer may be in a form of TeO_{3+1.}

In the vacuum insulating panel or method of any of the preceding sixteen paragraphs, the first seal layer may comprise tellurium oxide, and a ratio TeO₄:TeO₃ in the first seal layer may be from about 0.05 to 0.40, more preferably from about 0.10 to 0.30.

In the vacuum insulating panel or method of any of the preceding seventeen paragraphs, the first seal layer may comprise vanadium oxide including VO₂ and V₂O₅, and wherein more V in the first seal layer may be in a form of VO₂ than V₂O₅.

In the vacuum insulating panel or method of any of the preceding eighteen paragraphs, the first seal layer may comprise vanadium oxide, and from about 35-85%, more preferably from about 50-75%, of V in the first seal layer may be in a form of VO₂.

In the vacuum insulating panel or method of any of the preceding nineteen paragraphs, the first seal layer may comprise vanadium oxide, and from about 5-45% (more preferably from about 10-35%) of V in the first seal layer may be in a form of V₂O₅.

In the vacuum insulating panel or method of any of the preceding twenty paragraphs, the first seal layer may comprise vanadium oxide, and the vanadium oxide may comprise V₂O₃, wherein more V in the first seal layer may be in a form of VO₂ than V₂O₃. From about 6-20% of the V in the first seal layer may be in a form of V₂O₃.

In the vacuum insulating panel or method of any of the preceding twenty-one paragraphs, the seal may further comprise a second seal layer (e.g., 31 or 32), wherein the first seal layer (e.g., 30) may be a main seal layer and the second seal layer (e.g., 31 or 32) may be a primer layer.

In the vacuum insulating panel or method of any of the preceding twenty-two paragraphs, the seal may further comprise a second seal layer (e.g., 31 or 32), wherein the second seal layer may comprise bismuth oxide and boron oxide.

In the vacuum insulating panel or method of any of the preceding twenty-three paragraphs, the seal may further comprise a second seal layer (e.g., 31 or 32), wherein the second seal layer may comprise from about 1-40 mol % bismuth and from about 3-40 mol % boron on an elemental basis, and may comprise at least two times more boron than bismuth on an elemental basis in terms of mol %. The second seal layer may have a density of from about 3.0-4.2 g/cm³, and/or the density of the second seal layer may be at least about 0.20 g/cm³ greater than the density of the first seal layer. The second seal layer may have a thermal conductivity of from 1.00 to 2.00 W/mK.

In the vacuum insulating panel or method of any of the preceding twenty-four paragraphs, the seal may further comprise a second seal layer (e.g., 31 or 32) and a third seal layer (e.g., the other of 31 or 32), and wherein for at least one location of the seal, the first seal layer has a first thickness, the second seal layer has a second thickness, and the third seal layer has a third thickness; and wherein the first thickness is greater than the second thickness and less than the third thickness. The second seal layer may have a density of from about 3.0-4.2 g/cm³, and/or the density of the second seal layer may be at least about 0.20 g/cm³ greater than the density of the first seal layer. The second seal layer may have a thermal conductivity of from 1.00 to 2.00 W/mK.

In the vacuum insulating panel or method of any of the preceding twenty-five paragraphs, the first seal layer may have a density of from about 2.8-4.0 g/cm³, more preferably from about 3.1-3.7 g/cm³.

In the vacuum insulating panel or method of any of the preceding twenty-six paragraphs, the first seal layer may have a thermal conductivity of from 0.75 to 1.00 W/mK.

In the vacuum insulating panel or method of any of the preceding twenty-seven paragraphs, the first seal layer may have a melting point (Tm) of from about 300 to 450 degrees C.

In the vacuum insulating panel or method of any of the preceding twenty-eight paragraphs, the seal may be substantially lead-free.

In the vacuum insulating panel or method of any of the preceding twenty-nine paragraphs, first seal layer may have an average particle size (D50) of no greater than about 20 μm.

In the vacuum insulating panel or method of any of the preceding thirty paragraphs, the first seal layer may comprise from about 40-70% wt. % tellurium oxide, from about 12-40 wt. % vanadium oxide, from about 3-30 wt. % aluminum oxide, and from about 1-25 wt. % silicon oxide.

In the vacuum insulating panel or method of any of the preceding thirty-one paragraphs, the first and second substrates may comprise glass substrates which may be tempered or heat strengthened.

In the vacuum insulating panel or method of any of the preceding thirty-two paragraphs, the seal may be a hermetic edge seal of the vacuum insulating panel.

In the vacuum insulating panel or method of any of the preceding thirty-three paragraphs, the panel may be configured for use in a window.

It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). Terms, such as “first”, “second”, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component. “Or” as used herein may cover both “and” and “or.”

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component. Thus, terms such as “connected” and “coupled” cover both direct and indirectly connections and couplings.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The word “about” as used herein means the identified value plus/minus 5%.

“On” as used herein covers both directly on, and indirectly on with intervening element(s) therebetween. Thus, for example, if element A is stated to be “on” element B, this covers element A being directly and/or indirectly on element B. Likewise, “supported by” as used herein covers both in physical contact with, and indirectly supported by with intervening element(s) therebetween.

Each embodiment herein may be used in combination with any other embodiment(s) described herein.

While the disclosure has been illustrated and described with reference to various example embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in combination with any other embodiment(s) described herein.

1. A vacuum insulating panel comprising:
a first substrate;
a second substrate;
a plurality of spacers provided in a gap between at least the first and second substrates, wherein the gap is at pressure less than atmospheric pressure;
a seal provided at least partially between at least the first and second substrates, the seal comprising a first seal layer; and
wherein the first seal layer comprises tellurium oxide and from about 0.1 to 20% (mol %) copper oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %.

2. The vacuum insulating panel of claim 1, wherein the first seal layer comprises from about 1-15% copper oxide (mol %).

3. The vacuum insulating panel of claim 1, wherein the first seal layer comprises from about 2-10% copper oxide (mol %).

4. The vacuum insulating panel of claim 1, wherein the first seal layer comprises from about 2-5% copper oxide (mol %).

5. The vacuum insulating panel of claim 1, wherein the copper oxide comprises CuOₓ, where x is from about 0.2 to 1.5.

6. The vacuum insulating panel of claim 1, wherein the copper oxide comprises CuOₓ, where x is from about 0.5 to 1.4.

7. The vacuum insulating panel of claim 1, wherein the copper oxide comprises CuOₓ, where x is from about 0.8 to 1.2.

8. The vacuum insulating panel of claim 1, wherein the copper oxide has an average particle size (D50) of from about 5 nm to 15 μm.

9. The vacuum insulating panel of claim 1, wherein the copper oxide has an average particle size (D50) of from about 5-500 nm.

10. The vacuum insulating panel of claim 1, wherein the copper oxide has an average particle size (D50) of from about 10-100 nm.

11. The vacuum insulating panel of claim 1, wherein the copper oxide comprises nanocrystals and/or nanoparticles.

12. The vacuum insulating panel of claim 1, wherein the first seal layer comprises from about 40-90% (mol %) tellurium oxide.

13. The vacuum insulating panel of claim 1, wherein the first seal layer comprises from about 40-70% (mol %) tellurium oxide.

14. The vacuum insulating panel of claim 1, wherein the first seal layer comprises from about 20-80% (wt. %) tellurium oxide.

15. The vacuum insulating panel of claim 1, wherein the first seal layer comprises from about 40-70% (wt. %) tellurium oxide.

16. The vacuum insulating panel of claim 1, wherein the tellurium oxide further comprises TeO₃₊₁, and wherein the first seal layer comprises more TeO₃ than TeO₃₊₁ by mol %.

17. The vacuum insulating panel of claim 1, wherein from about 60-95% of Te in the first seal layer is in a form of TeO₃.

18. The vacuum insulating panel of claim 1, wherein from about 70-90% of Te in the first seal layer is in a form of TeO₃.

19. The vacuum insulating panel of claim 1, wherein from about 3-35% of Te in the first seal layer is in a form of TeO₄.

20. The vacuum insulating panel of claim 1, wherein from about 5-25% of Te in the first seal layer is in a form of TeO₄.

21. The vacuum insulating panel of claim 20, wherein from about 1-9% of Te in the first seal layer is in a form of TeO₃₊₁.

22. The vacuum insulating panel of claim 1, wherein a ratio TeO₄:TeO₃ in the first seal layer is from about 0.05 to 0.40.

23. The vacuum insulating panel of claim 1, wherein a ratio TeO₄:TeO₃ in the first seal layer is from about 0.10 to 0.30.

24. The vacuum insulating panel of claim 1, wherein the first seal layer further comprises vanadium oxide including VO₂ and V₂O₅, and wherein more V in the first seal layer is in a form of VO₂ than V₂O₅.

25. The vacuum insulating panel of claim 24, wherein from about 35-85% of the V in the first seal layer is in a form of VO₂.

26. The vacuum insulating panel of claim 24, wherein from about 50-75% of the V in the first seal layer is in a form of VO₂.

27. The vacuum insulating panel of claim 24, wherein from about 5-45% of the V in the first seal layer is in a form of V₂O₅.

28. The vacuum insulating panel of claim 24, wherein from about 10-35% of the V in the first seal layer is in a form of V₂O₅.

29. The vacuum insulating panel of claim 24, wherein the vanadium oxide further comprises V₂O₃, and wherein more V in the first seal layer is in a form of VO₂ than V₂O₃.

30. The vacuum insulating panel of claim 29, wherein from about 6-20% of the V in the first seal layer is in a form of V₂O₃.

31. The vacuum insulating panel of claim 1, wherein the seal further comprises a second seal layer, wherein the first seal layer is a main seal layer and the second seal layer is a primer layer.

32. The vacuum insulating panel of claim 31, wherein the second seal layer comprises bismuth oxide and boron oxide.

33. The vacuum insulating panel of claim 31, wherein the second seal layer comprises from about 1-40 mol % bismuth and from about 3-40 mol % boron on an elemental basis, and comprises at least two times more boron than bismuth on an elemental basis in terms of mol %.

34. The vacuum insulating panel of claim 31, wherein the seal further comprises a third seal layer, and wherein for at least one location of the seal, the first seal layer has a first thickness, the second seal layer has a second thickness, and the third seal layer has a third thickness; and wherein the first thickness is greater than the second thickness and less than the third thickness.

35. The vacuum insulating panel of claim 31, wherein the first seal layer has a density of from about 2.8-4.0 g/cm³, the second seal layer has a density of from about 3.0-4.2 g/cm³, and wherein the density of the second seal layer is at least about 0.20 g/cm³ greater than the density of the first seal layer.

36. The vacuum insulating panel of claim 31, wherein the second seal layer has a thermal conductivity of from 1.00 to 2.00 W/mK, and the first seal layer has a thermal conductivity of from 0.75 to 1.00 W/mK.

37. The vacuum insulating panel of claim 1, wherein the first seal layer has a density of from about 2.8-4.0 g/cm³.

38. The vacuum insulating panel of claim 1, wherein the first seal layer has a density of from about 3.1-3.7 g/cm³.

39. The vacuum insulating panel of claim 1, wherein the first seal layer has a melting point (Tm) of from about 300 to 450 degrees C.

40. The vacuum insulating panel of claim 1, wherein the seal is substantially lead-free.

41. The vacuum insulating panel of claim 1, wherein first seal layer has an average particle size (D50) of no greater than about 20 μm.

42. The vacuum insulating panel of claim 1, wherein the first seal layer comprises from about 40-70% wt. % tellurium oxide, from about 12-40 wt. % vanadium oxide, from about 3-30 wt. % aluminum oxide, and from about 1-25 wt. % silicon oxide.

43. The vacuum insulating panel of claim 1, wherein the first and second substrates comprise glass substrates.

44. The vacuum insulating panel of claim 1, wherein the first and second substrates comprise tempered glass substrates or heat strengthened glass substrates.

45. The vacuum insulating panel of claim 1, wherein the seal is a hermetic edge seal of the vacuum insulating panel.

46. The vacuum insulating panel of claim 1, wherein the panel is configured for use in a window.

47. A vacuum insulating panel comprising:
a first substrate;
a second substrate;
a plurality of spacers provided in a gap between at least the first and second substrates, wherein the gap is at pressure less than atmospheric pressure;
a seal provided at least partially between at least the first and second substrates, the seal comprising a first seal layer;
wherein the first seal layer comprises tellurium oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %; and
wherein the first seal layer further comprises from about 0.1 to 20% (mol %) of at least one of: copper, copper oxide, molybdenum oxide, nickel oxide, aluminum, aluminum oxide, and/or silver oxide.

48. The vacuum insulating panel of claim 47, wherein the first seal layer comprises from about 1 to 15% (mol %) of at least one of: copper, copper oxide, molybdenum oxide, nickel oxide, aluminum, aluminum oxide, and/or silver oxide.

49. The vacuum insulating panel of claim 47, wherein the first seal layer comprises from about 2 to 10% (mol %) of at least one of: copper, copper oxide, molybdenum oxide, nickel oxide, aluminum, aluminum oxide, and/or silver oxide.

50. The vacuum insulating panel of claim 47, wherein the first seal layer comprises from about 2 to 5% (mol %) of at least one of: copper, copper oxide, molybdenum oxide, nickel oxide, aluminum, aluminum oxide, and/or silver oxide.

51. The vacuum insulating panel of claim 47, wherein the at least one of: copper, copper oxide, molybdenum oxide, nickel oxide, aluminum, aluminum oxide, and/or silver oxide has an average particle size (D50) of from about 5-500 nm.

52. The vacuum insulating panel of claim 47, wherein the at least one of: copper, copper oxide, molybdenum oxide, nickel oxide, aluminum, aluminum oxide, and/or silver oxide has an average particle size (D50) of from about 10-100 nm.

53. The vacuum insulating panel of claim 47, wherein the at least one of: copper, copper oxide, molybdenum oxide, nickel oxide, aluminum, aluminum oxide, and/or silver oxide comprises nanocrystals and/or nanoparticles.

54. The vacuum insulating panel of claim 47, wherein the first seal layer comprises from about 40-90% (mol %) tellurium oxide.

55. The vacuum insulating panel of claim 47, wherein the tellurium oxide further comprises TeO₃₊₁, and wherein the first seal layer comprises more TeO₃ than TeO₃₊₁ by mol %.

56. The vacuum insulating panel of claim 47, wherein from about 60-95% of Te in the first seal layer is in a form of TeO₃.

57. The vacuum insulating panel of claim 47, wherein from about 5-25% of Te in the first seal layer is in a form of TeO₄.

58. The vacuum insulating panel of claim 56, wherein from about 1-9% of Te in the first seal layer is in a form of TeO_{3+1.}

59. The vacuum insulating panel of claim 47, wherein a ratio TeO₄:TeO₃ in the first seal layer is from about 0.05 to 0.40.

60. The vacuum insulating panel of claim 47, wherein a ratio TeO₄:TeO₃ in the first seal layer is from about 0.10 to 0.30.

61. The vacuum insulating panel of claim 47, wherein the first seal layer further comprises vanadium oxide including VO₂ and V₂O₅, and wherein more V in the first seal layer is in a form of VO₂ than V₂O₅.

62. A vacuum insulating panel comprising:
a first glass substrate;
a second glass substrate;
a plurality of spacers provided in a gap between at least the first and second glass substrates, wherein the gap is at pressure less than atmospheric pressure;
a seal provided at least partially between at least the first and second substrates, the seal comprising a first seal layer;
wherein the first seal layer has a melting point (Tm) of from about 300 to 450 degrees C.; and
wherein the first seal layer comprises tellurium oxide and from about 0.1 to 20% (mol %) copper oxide.

63. The vacuum insulating panel of claim 62, wherein the first seal layer comprises from about 1-15% copper oxide (mol %).

64. The vacuum insulating panel of claim 62, wherein the first seal layer comprises from about 2-10% copper oxide (mol %).

65. The vacuum insulating panel of claim 62, wherein the first seal layer comprises from about 2-5% copper oxide (mol %).

66. The vacuum insulating panel of claim 62, wherein the copper oxide comprises CuOₓ, where x is from about 0.2 to 1.5.

67. The vacuum insulating panel of claim 62, wherein the copper oxide comprises CuOₓ, where x is from about 0.8 to 1.2.

68. The vacuum insulating panel of claim 62, wherein the copper oxide has an average particle size (D50) of from about 5 nm to 15 μm.

69. The vacuum insulating panel of claim 62, wherein the copper oxide has an average particle size (D50) of from about 5-500 nm.

70. The vacuum insulating panel of claim 62, wherein the copper oxide has an average particle size (D50) of from about 10-100 nm.

71. The vacuum insulating panel of claim 62, wherein the copper oxide comprises nanocrystals and/or nanoparticles.

72. The vacuum insulating panel of claim 62, wherein the first seal layer comprises from about 40-90% (mol %) tellurium oxide.

73. The vacuum insulating panel of claim 62, wherein a ratio TeO₄:TeO₃ in the first seal layer is from about 0.05 to 0.40.

74. The vacuum insulating panel of claim 62, wherein the first seal layer further comprises vanadium oxide including VO₂ and V₂O₅, and wherein more V in the first seal layer is in a form of VO₂ than V₂O₅.

75. A vacuum insulating panel comprising:
a first glass substrate;
a second glass substrate;
a plurality of spacers provided in a gap between at least the first and second glass substrates, wherein the gap is at pressure less than atmospheric pressure;
a seal provided at least partially between at least the first and second substrates, the seal comprising a seal layer;
wherein the seal layer has an average D50 particle size of from about 1-25 μm; and
wherein the seal layer comprises a metal oxide configured to increase the thermal diffusivity and/or thermal conductivity of the seal layer compared to if the metal oxide was not present, wherein the metal oxide has an average particle size (D50) of from about 5-500 nm.

76. The vacuum insulating panel of claim 75, wherein the metal oxide comprises at least one of copper oxide, aluminum oxide, silver oxide, or molybdenum oxide.

77. The vacuum insulating panel of claim 75, wherein the metal oxide comprises at least one of copper oxide, aluminum oxide, or silver oxide.

78. The vacuum insulating panel of claim 75, wherein the metal oxide comprises copper oxide, and the seal layer comprises from about 0.1 to 20% (mol %) copper oxide.

79. The vacuum insulating panel of claim 75, wherein the metal oxide has an average particle size (D50) of from about 10-100 nm.

80. The vacuum insulating panel of claim 75, wherein the seal layer has a melting point (Tm) of from about 300 to 450 degrees C.

81. The vacuum insulating panel of claim 75, wherein the seal layer comprises tellurium oxide.

82. The vacuum insulating panel of claim 81, wherein the seal layer comprises from about 40-90% (mol %) tellurium oxide.

83. The vacuum insulating panel of claim 81, wherein a ratio TeO₄:TeO₃ in the seal layer is from about 0.05 to 0.40.

84. The vacuum insulating panel of claim 75, wherein the seal layer comprises boron oxide and bismuth oxide.

85. The vacuum insulating panel of claim 84, wherein the seal layer is a primer layer.

86. A vacuum insulating panel comprising:
a first substrate;
a second substrate;
a plurality of spacers provided in a gap between at least the first and second substrates, wherein the gap is at pressure less than atmospheric pressure;
a seal provided at least partially between at least the first and second substrates, the seal comprising a first seal layer and a second seal layer;
wherein the first seal layer comprises tellurium oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %;
wherein the second seal layer comprises boron oxide and/or bismuth oxide;
wherein at least one of the first and second seal layers comprises from about 0.1 to 20% (mol %) of at least one of: copper, copper oxide, molybdenum oxide, nickel oxide, aluminum, aluminum oxide, and/or silver oxide.

87. The vacuum insulating panel of claim 86, wherein the second seal layer comprises from about 1-40 mol % bismuth and from about 3-40 mol % boron on an elemental basis, and comprises at least two times more boron than bismuth on an elemental basis in terms of mol %.

88. The vacuum insulating panel of claim 86, wherein the at least one of: copper, copper oxide, molybdenum oxide, nickel oxide, aluminum, aluminum oxide, and/or silver oxide, has an average particle size (D50) of from about 5-500 nm.

89. The vacuum insulating panel of claim 86, wherein at least one of the first and second seal layers comprises from about 1-15% copper oxide (mol %).

90. The vacuum insulating panel of claim 86, wherein at least one of the first and second seal layers comprises from about 2-10% copper oxide (mol %).

91. The vacuum insulating panel of claim 89, wherein the copper oxide has an average particle size (D50) of from about 5-500 nm.

92. The vacuum insulating panel of claim 89, wherein the copper oxide has an average particle size (D50) of from about 10-100 nm.

93. The vacuum insulating panel of claim 86, wherein the first seal layer further comprises vanadium oxide including VO₂ and V₂O₅, and wherein more V in the first seal layer is in a form of VO₂ than V₂O₅.

94. The vacuum insulating panel of claim 86, wherein both of the first and second seal layers comprise from about 0.1 to 20% (mol %) of at least one of: copper, copper oxide, molybdenum oxide, nickel oxide, aluminum, aluminum oxide, and/or silver oxide.

95. The vacuum insulating panel of claim 86, wherein both of the first and second seal layers comprise from about 1-15% copper oxide (mol %).

96. The vacuum insulating panel of claim 86, wherein the seal comprises a third seal layer, wherein the third seal layer comprises an oxide of boron and/or bismuth, and further comprises from about 1-15% copper oxide (mol %).

97. A vacuum insulating panel comprising:
a first substrate;
a second substrate;
a plurality of spacers provided in a gap between at least the first and second substrates, wherein the gap is at pressure less than atmospheric pressure;
a seal provided at least partially between at least the first and second substrates, the seal comprising a seal layer;
wherein the seal layer comprises boron oxide and bismuth oxide, wherein the seal layer comprises at least two times more boron than bismuth on an elemental basis in terms of mol %; and
wherein the seal layer further comprises from about 0.1 to 20% (mol %) of at least one of: copper, copper oxide, molybdenum oxide, nickel oxide, aluminum, aluminum oxide, and/or silver oxide.

98. The vacuum insulating panel of claim 97, wherein the seal layer comprises from about 1-15% copper oxide (mol %).

99. The vacuum insulating panel of claim 98, wherein the copper oxide has an average particle size (D50) of from about 5-500 nm.

100. A method of making a vacuum insulating panel, the vacuum insulating panel comprising a first glass substrate, a second glass substrate, a plurality of spacers provided in a gap between at least the first and second glass substrates, and a seal provided at least partially between at least the first and second glass substrates, the seal comprising a seal layer; wherein the method comprises:
providing seal material for the seal layer in a location between at least the first and second glass substrates;
heating, using a laser beam from a laser, to form the seal;
wherein the seal layer and/or the seal material comprises CuOₓ, where x is from about 0.2 to 1.5, and wherein x is based on a wavelength of the laser beam; and
after forming the seal, evacuating the gap to a pressure less than atmospheric pressure.

101. The method of claim 100, wherein x is a value so that a peak absorption of the CuOₓ is within about 150 nm of the wavelength of the laser beam.

102. The method of claim 100, comprising selecting x so that the CuOₓ has a high wavelength absorption proximate a wavelength of the laser beam.

103. The method of claim 100, wherein the seal layer comprises from about 0.1 to 20% (mol %) CuOₓ.

104. The method of claim 100, wherein the seal layer comprises from about 2-10% (mol %) CuOₓ.

105. The method of claim 100, wherein the seal layer comprises tellurium oxide, wherein the tellurium oxide has the highest mol % of any metal oxide in the seal layer, the tellurium oxide comprising TeO₄ and TeO₃, and wherein the seal layer comprises more TeO₃ than TeO₄ in terms of mol %.

106. The method of claim 100, wherein the seal layer comprises boron oxide and bismuth oxide, and comprises at least two times more boron than bismuth on an elemental basis in terms of mol %.

107. The method of claim 100, wherein the seal further comprises one or two additional seal layers, each of which may or may not comprise from about 0.1 to 20% (mol %) copper oxide.

108. A method of making a vacuum insulating panel, the vacuum insulating panel comprising a first glass substrate, a second glass substrate, a plurality of spacers provided in a gap between at least the first and second glass substrates, and a seal provided at least partially between at least the first and second glass substrates, the seal comprising a seal layer; wherein the method comprises:
providing seal material for the seal layer in a location between at least the first and second glass substrates;
heating, using a laser beam from a laser, in order to form the seal;
wherein the seal material and/or the seal layer comprises from about 0.1 to 20% (mol %) of at least one of: copper, copper oxide, molybdenum oxide, nickel oxide, aluminum, aluminum oxide, and/or silver oxide;
wherein said at least one of copper, copper oxide, molybdenum oxide, nickel oxide, aluminum, aluminum oxide, and/or silver oxide is configured to increase a thermal diffusivity and/or thermal conductivity of the seal material and/or seal layer and so as to have a peak and/or high absorption within about 150 nm of the wavelength of the laser beam; and
after forming the seal, evacuating the gap to a pressure less than atmospheric pressure.

109. The method of claim 108, wherein the seal layer comprises from about 0.1 to 20% (mol %) CuOₓ, where x is from about 0.2 to 1.5.

110. The method of claim 108, wherein the seal layer comprises tellurium oxide, wherein the tellurium oxide has the highest mol % of any metal oxide in the seal layer, the tellurium oxide comprising TeO₄ and TeO₃, and wherein the seal layer comprises more TeO₃ than TeO₄ in terms of mol %.

111. The method of claim 108, wherein the seal layer comprises from about 1-40 mol % bismuth and from about 3-40 mol % boron on an elemental basis, and comprises at least two times more boron than bismuth on an elemental basis in terms of mol %.
